(19) United States
(12) Patent Application Publication
(10) Pub. No.: US 2015/0201565 A1
(43) Pub. Date: Jul. 23, 2015

(54) CANOPY

(71) Applicant: Extenday IP Limited, Auckland, OT (NZ)

(72) Inventor: Jonathan Dallas Toye, Auckland (NZ)

(21) Appl. No.: 14/415,551

(22) PCT Filed: Jul. 16, 2013
(86) PCT No.: PCT/NZ2013/000125

§ 371 Date: Jan. 16, 2015

(30) Foreign Application Priority Data
Jul. 16, 2012 (NZ) 601277
Dec. 21, 2012 (NZ) 605223
Mar. 15, 2013 (NZ) 608349
Apr. 24, 2013 (NZ) 609827
May 15, 2013 (NZ) 610658

(51) Int. Cl. A01G 13/00

(52) U.S. Cl. CPC A01G 13/0206

(57) ABSTRACT

A canopy comprises a sheet material that forms a main portion of the canopy having a greater length than width. The canopy comprises vent apertures in the sheet material. The vent apertures are spaced apart along the length of the canopy. The vent apertures may have vent covers. The vent cover restricts water from flowing or entering the vent aperture and passing from outside the canopy to inside the canopy but allows air to move upwards though the vent, or relieves pressure from beneath the canopy.

### FIELD OF THE INVENTION

The invention relates to materials for use over growing plants such as grape or berry or other fruit vines, bushes, or fruit trees (herein: plants) in agricultural applications.

### BACKGROUND OF THE INVENTION

U.S. Pat. No. 7,523,584 discloses a weather cover for agricultural use over plants which comprises a cover comprising flaps which overlap like tiles or weatherboards.

FIGS. 5 and 6 show puncture damage to a prior art canopy caused by wear from a supporting pole.

### SUMMARY OF THE INVENTION

An object of the present invention is to provide a canopy that at least provides the industry with a useful choice.

In one aspect the invention comprises a canopy comprising sheet material having a greater length than width and having a reinforced centre lengthwise portion, which has heavier construction than the material on either side of the reinforced centre portion.

In some embodiments the material on either side of the reinforced centre portion and centre portion comprises at least one main web of canopy material, and the reinforced centre portion comprises at least one additional material layer secured to the at least one main web of canopy material.

In some embodiments the reinforced centre portion includes a layer of reinforcing material bonded or heat bonded to the main web of canopy material.

In some embodiments the reinforced centre portion includes a layer of reinforcing material secured to the main web of canopy material without piercing of the main web of canopy material, for example without stitching.

In some embodiments the main web and the additional material layer each comprise a woven sheet material woven from warp tapes and weft tapes, and a coating layer coating at least one side of the woven sheet material, and the main web and the additional material layer are joined together by melting the coating layers to penetrate through and bond the two woven sheet materials together.

In some embodiments the main web and the additional material layer each comprise a coating layer on both sides of the woven sheet material.

In some embodiments the coating layer of the main web is at a top side of the canopy and the coating layer of the additional material layer is at an underside of the canopy.

In some embodiments the coating layer is an extruded plastic sheet melted to cover a side of the woven sheet material.

In some embodiments the sheet material is woven from warp tapes and weft tapes, and warp tapes in the reinforced centre portion are heavier than warp tapes on either side of the reinforced centre portion.

In some embodiments the warp tapes in the reinforced centre portion have a weight that is at least 5% greater than the weight of the warp tapes on either side of the reinforced centre portion, wherein the width of the warp tapes in the reinforced centre portion is the same as the width of the warp tapes on either side of the reinforced centre portion.

In some embodiments the warp tapes in the reinforced centre portion have a thickness that is at least 5% greater than the thickness of the warp tapes on either side of the reinforced centre portion.

In some embodiments the layer of reinforcing material is a coating layer applied to the main web of the canopy.

In some embodiments the canopy comprises reinforced areas in other regions of the canopy that are reinforced according to the structure of the central reinforced region of the canopy as described in any one or more of the above statements.

Preferably the canopy includes securing features within the region of the reinforced centre portion. Preferably the canopy includes at least one flap extending from the reinforced centre portion, and at least one securing feature is located in or on the flap. Preferably the flap extends for a majority of the length of the canopy. Preferably the securing feature is an aperture in the flap. The securing feature may include a reinforcing grommet or eyelet. In some embodiments the flap comprises at least one layer of the main web of canopy material. The flap may comprise two layers of the main web of canopy material bonded together. The two layers may join at a fold. Alternatively the two layers may each end at an edge. Where the reinforced centre portion is provided by an additional material layer, the additional material layer may be provided into the flap as well as adjacent the flap, or may be provided only adjacent to the flap. The flap may be provided with one or more additional reinforcing layers. For example an edging tape may be folded over the outside of the flap. The tape may be secured in any suitable fashion such as stitching, adhesive or heat bonding. The edging tape may be sufficiently wide to substantially cover both faces of the flap. The flap may extend outwards from an outside or upward facing surface of the canopy. In some embodiments the flap may extend inwards from an inside or downward facing surface of the canopy.

Preferably the canopy, or at least the parts of the canopy that are outside the reinforced portion, are transparent or translucent to transmit light (or solar radiation) to plants beneath the canopy in use. In some embodiments the reinforced centre portion of the canopy is transparent or translucent to transmit light (or solar radiation) to plants beneath the canopy in use

In some embodiments the sheet material of the canopy is white in colour or slightly white. This may provide diffuse light properties. Alternatively the sheet material may be other colours or comprise particular pigments to influence the light quality beneath the canopy.

In some embodiments the sheet material of the canopy comprises a weave of warp and weft tapes. In some embodiments the sheet material comprises a weave of warp and weft tapes and at least one coating layer on the weave. The coating or laminated layer may be substantially water impermeable. The coating layer may be heat bondable. A coating layer may be provided on both sides of the weave. Where certain properties of the main web of the canopy are set out below, these properties are properties of the combined weave and any coatings. The properties may be provided in part by the material of the weave, by the material of the coating, or by the material of the weave and the coating combined. In some embodiments the material comprises a weave of warp and weft tapes and the structure of the weave is altered in the centre lengthwise part of the material relative to the side parts of the material so that the weave is more durable in the centre part of the material than the side parts of the material.

In some embodiments the reinforced centre portion of the canopy has a width of between 3 to 50 cm, or 5 to 30 cm or 8 to 15 cm, and the overall width of the canopy is between 1-12 metres, or 2 to 5 metres or 2.5 to 3.5 metres, for example. In some embodiments the overall length of the canopy is between 2 m and 200 m, or between 15 m and 200 m, or between 30 m and 150 m or above 40 m.

The sheet material of the canopy, outside the reinforced centre portion, may be water impermeable.

Edge portions of the canopy may include fastening features. For example edge portions of the canopy may include a reinforced edge region and a plurality of spaced apart fastening locations, such as rings, hooks or eyes or apertures located in the reinforced region.

In use the canopy is supported over the plant(s), for example by clipping or otherwise attaching lengthwise edges of the material to cables or wires along rows of plants on either side, in a garden, field crop, orchard or vineyard, with the reinforced centre portion of the canopy supported over one or more of a post, posts, cable or line. The canopy will typically remain in place for some months, before being removed and reused in a subsequent growing season or on another crop in the same growing season, but in some cases may remain in place over multiple growing seasons.

In some embodiments the material may incorporate a compound or compounds added to cause or increase the extent to which the material reflects and/or absorbs radiation from the earth (terrestrial (long wave or infrared) radiation). Thus when the material is placed over plants it will assist in retaining heat beneath the material, which may be desirable for some plants or applications.

In some embodiments the material may incorporate a compound or compounds added to cause or increase the extent to which the material allows transmission and/or absorption of radiation from the earth (terrestrial (long wave or infrared) radiation). Thus when the material is placed over plants it will assist in releasing the heat beneath the material, which may be desirable for some plants or applications.

In other embodiments the material may incorporate a compound or compounds added to cause or increase the extent to which the material reflects and/or absorbs solar radiation. Thus when the material is placed over plants it will assist in cooling beneath the material, which may be desirable for some plants or applications.

In other embodiments the material may incorporate a compound or compounds added to cause or increase the extent to which the material allows transmission and/or absorption of solar radiation. Thus when the material is placed over plants it will assist in increasing the heat beneath the material, which may be desirable for some plants or applications.

In some embodiments the material may incorporate a compound or compounds added to cause or increase the extent to which the material diffuses solar radiation. Thus when the material is placed over plants it will assist in cooling beneath the material.

In some embodiments the material may incorporate a compound or compounds added to eliminate or reduce the extent to which the material forms water droplets of, for example, condensation. Such anti drip additives may comprise, for example, a surfactant. The anti drip additive may be included in coatings applied to a woven substrate, or in polymer tapes of the woven substrate, or both.

In some embodiments the canopy comprises vent apertures in the reinforced centre portion.

In another aspect, the invention comprises a canopy comprising sheet material having a greater length than width, and vent apertures in the sheet material. In some embodiments the canopy comprises vent apertures in a longitudinally extending centre portion of the canopy. In some embodiments the canopy comprises vent apertures in the sheet material on either side of the centre portion between the centre portion and each longitudinal edge of the canopy. In some embodiments the canopy comprises vent apertures in a longitudinal edge region of the canopy. In some embodiments the canopy comprises vent apertures in a longitudinally extending centre portion of the canopy and vent apertures in a longitudinal edge region of the canopy and the vent apertures in the centre region are spaced closer together along the length of the canopy compared to the vent apertures in the edge region of the canopy. In some embodiments the canopy comprises vent apertures in a longitudinally extending centre portion of the canopy and vent apertures in a longitudinal edge portion of the canopy and the vent apertures in the edge portion are spaced closer together along the length of the canopy compared to the vent apertures in the centre portion of the canopy. In some embodiments the canopy comprises vent apertures in a longitudinally extending centre portion of the canopy and vent apertures in a longitudinal edge region of the canopy and the vent apertures in the centre region comprise a larger diameter than the vent apertures in the edge region of the canopy. In some embodiments the canopy comprises vent apertures in an intermediate region of the canopy between a longitudinally extending edge region of the canopy and a longitudinally extending centre portion of the canopy. In some embodiments the canopy comprises vent apertures in a longitudinally extending centre portion of the canopy and vent apertures in an intermediate region of the canopy between a longitudinal edge region of the canopy and the centre portion and the vent apertures in the centre portion are spaced closer together along the length of the canopy compared to the vent apertures in the intermediate region of the canopy. In some embodiments the canopy comprises vent apertures in a longitudinally extending centre portion of the canopy and vent apertures in an intermediate region of the canopy between a longitudinally extending edge region of the canopy and the centre portion, and the vent apertures in the centre portion comprise a larger diameter than the vent apertures in the intermediate region of the canopy. In some embodiments the canopy comprises vent apertures in an intermediate region of the canopy between the longitudinally extending edge region of the canopy and a centre portion of the canopy, and the vent apertures in the intermediate region are spaced closer together along the length of the canopy compared to the vent apertures in the edge region. In some embodiments the canopy includes securing features within the centre portion and each vent aperture in the centre portion is located adjacent to a said securing feature.

In some embodiments the canopy comprises a vent cover over each of the vent apertures. In some embodiments the canopy comprises vent apertures in a longitudinally extending centre portion of the canopy, vent apertures in a longitudinal edge region of the canopy, a vent cover over each of the vent apertures in the longitudinally centre portion of the canopy, and no vent covers over the vent apertures in the longitudinal edge region of the canopy.

In some embodiments the canopy comprises vent covers comprising a heavier weight sheet material than the sheet material of the main portion of the canopy. In some embodiments the canopy comprises vent covers comprising a lighter weight sheet material than the sheet material of the main portion of the canopy. In some embodiments the canopy comprises vent covers comprising a relatively light weight sheet material having a weight of 50 to 200 g/m2, or 50 to 100 g/m2. In some embodiments the canopy comprises vent covers comprising a relatively intermediate weight sheet material having a weight of 100 to 400 g/m2, or 100 to 200 g/m2. In some embodiments the canopy comprises vent covers comprising a relatively heavy weight sheet material having a weight of 200 to 1000 g/m2, or 200 to 600 g/m2.

In some embodiments the canopy comprises vent covers in a first region of the canopy formed from a first sheet material and vent covers in a second region of the canopy formed from a second sheet material, the first sheet material having a heavier weight than the second sheet material. In some embodiments the vent apertures in the first region of the canopy comprise a larger diameter than the vent apertures in the second region of the canopy. In some embodiments the first region is a central region of the canopy. In some embodiments the second region is an edge region of the canopy. In some embodiments the canopy comprises vent covers formed from a third sheet material in a third region of the canopy, the third sheet material having a weight lighter than the first sheet material and heavier than the second sheet material. In some embodiments the third region of the canopy is an intermediate region of the canopy between a central region and an edge region.

In some embodiments the vent cover is formed from a piece or strip of material folded about a longitudinal fold line, the vent aperture being formed through an inner side of the piece or strip of material and the sheet material of the canopy, and an outer side of the piece or strip of material forming the vent cover over the vent aperture. In some embodiments the vent cover is formed from a strip or sheet material formed in a cylinder, the cylinder folded or flattened to form an inner side and an outer side, the vent aperture being formed through the inner side, and the outer side of the cylinder forming the vent cover over the vent aperture. In some embodiments the vent cover is attached to the sheet material of the canopy by a grommet forming the vent aperture through the sheet material of the canopy and the inner side. In some embodiments the outer side is attached to the inner side along a longitudinal edge of the vent cover above the vent aperture relative to a ridge line of the canopy. In some embodiments the outer side is attached to the inner side along a longitudinal edge of the vent cover below the vent aperture relative to a ridge line of the canopy. In some embodiments the outer side is releasably attached to the inner side along a longitudinal edge of the vent cover below the vent aperture relative to the ridge line of the canopy. In some embodiments the lateral dimension of the outer side is greater than the lateral dimension of the inner side so that the outer side arches outwardly from the vent aperture. In some embodiments, a lateral side or sides of the vent cover may be attached to the canopy in part or in full. For example, the vent cover is fixed to the canopy down each lateral side of the vent cover from the top of the vent cover to approximately half way down each lateral side of the vent cover. In some embodiments at least an upper portion of a lateral edge or edges of the outer side are attached to the inner side. In some embodiments, the inner side of the vent cover sheet material is attached to the reinforced portion of the canopy around a perimeter of the vent aperture by bonding with adhesives or by heat, or by stitching, or a combination of these methods. In some embodiments the vent aperture may include a reinforcing grommet or eyelet.

In some embodiments, a separate vent cover is provided at each vent aperture. In other embodiments, a continuous cover or flap extending longitudinally along the canopy may cover more than one vent aperture.

In some embodiments the vent cover is formed from a piece of sheet material. In some embodiments the sheet material is woven from flat warp and weft tapes of a plastics material. In some embodiments the sheet material is a plastics film. In some embodiments the sheet material is woven from flat warp and weft tapes that have been coated with a plastic film material on one or both sides. In some embodiments the vent cover is formed from the same sheet material as the canopy sides.

In some embodiments the canopy includes securing features within the region of the centre portion and each vent aperture in the centre portion is located adjacent to a said securing feature. In some embodiments the vent apertures in the centre portion of the canopy are located on either side of a ridge of the canopy, and the vent apertures on each side of the ridge are aligned along the canopy. In some embodiments the vent apertures in the centre portion of the canopy are located on either side of a ridge of the canopy, and the vent apertures on one side of the ridge being staggered with the vent apertures on the other side of the ridge along the canopy. In some embodiments the vent apertures are spaced apart in a longitudinal direction along the canopy.

In some embodiments a longitudinally extending centre portion is reinforced, the reinforced centre portion having a heavier construction than the sheet material on either side of the reinforced centre portion. In some embodiments the material on either side of the reinforced centre portion and the reinforced centre portion comprises at least one main web of canopy material, and the reinforced centre portion comprises at least one additional material layer secured to the at least one main web of canopy material. In the additional layer of reinforcing material is bonded or heat bonded to the main web of canopy material. In some embodiments the additional layer of reinforcing material is secured to the main web of canopy material without piercing the main web of canopy material.

In some embodiments the longitudinal edge region of the canopy is reinforced, the reinforced longitudinal edge region having a heavier construction than the sheet material either side of or adjacent to the reinforced edge region. In some embodiments the longitudinal intermediate region of the canopy is reinforced, the reinforced longitudinal intermediate region having a heavier construction than the sheet material either side of the reinforced edge region.

In some embodiments the sheet material is woven from warp tapes and weft tapes, and warp tapes in the reinforced centre portion are heavier than warp tapes on either side of the reinforced centre portion. In some the warp tapes in the reinforced centre portion have a weight that is at least 5% greater than the weight of the warp tapes on either side of the reinforced centre portion, wherein the width of the warp tapes in the reinforced centre portion is the same as the width of the warp tapes on either side of the reinforced centre portion. In some embodiments the width of the warp tapes in the reinforced centre portion and the width of the warp tapes on either side of the reinforced centre portion is 2 mm to 3 mm, and the weight of the tapes on either side of the reinforced centre portion is 900 to 1400 denier. In some embodiments the warp tapes in the reinforced centre portion have a thickness that is at least 5% greater than the thickness of the warp tapes on either side of the reinforced centre portion. In some embodiments the thickness of the warp tapes on either side of the reinforced centre portion is 25 micron to 100 micron.

In some embodiments the canopy includes securing features within the region of the reinforced centre portion. In some embodiments the canopy comprises a longitudinally extending flap in the reinforced centre portion, and the securing features are located in or on the flap. In some embodiments the sheet material comprises at least two main webs of canopy material, longitudinal edge portions of the two main webs secured together in the reinforced centre portion to form the flap. In some embodiments the sheet material comprises at least one main web of canopy material and the flap is folded from the main web along a longitudinal fold line in the reinforced centre portion to comprise at least two layers of the main web folded together. In some embodiments the reinforced centre portion comprises at least one additional material layer secured to the at least one main web of canopy material, and the additional material layer extends into the flap. In some embodiments the flap comprises a strip of material attached to the sheet material to reinforce the flap. In some embodiments the strip of material is provided to one side of the flap. In some embodiments the strip of material is provided to both sides of the flap. In some embodiments the canopy, or at least the parts of the canopy that are outside the reinforced centre portion, are transparent or translucent to transmit light to plants beneath the canopy in use. In some embodiments the canopy, or at least the parts of the canopy that are outside the reinforced centre portion, are transparent or translucent to transmit solar radiation to plants beneath the canopy in use. In some embodiments the reinforced centre portion is transparent or translucent to transmit solar radiation to plants beneath the canopy in use. In some embodiments the canopy comprises said vent apertures in the reinforced centre portion, said vent apertures being located between a ridge line of the canopy and a longitudinal edge of the reinforced portion. In some embodiments the vent apertures in the reinforced centre portion are located approximately midway between a ridge line of the canopy and a longitudinal edge of the reinforced portion. In some embodiments the vent apertures in the reinforced centre portion are located closer to the centre of the canopy than an edge of the reinforced portion of the canopy. In some embodiments the vent apertures are placed at or adjacent to the edge of the reinforced centre portion. In some embodiments, the vent apertures may be placed adjacent to the ridge line or flap of the canopy.

In some embodiments, the canopy includes securing features within the region of the reinforced centre portion and each vent aperture in the reinforced centre portion is located adjacent to a said securing feature. In some embodiments the vent apertures are spaced apart in a longitudinal direction along the canopy. In some embodiments, the vent apertures are located at alternate sides of a ridge along the length of the canopy. In some embodiments the vent apertures are provide to one side of the canopy only.

In some embodiments the sheet material comprises a woven sheet material woven from warp tapes and weft tapes, and a coating layer on one or both sides of the woven sheet material.

In another aspect, in the invention comprises a canopy having a greater length than width comprising:
at least one side extending between a longitudinal canopy ridge line and a longitudinal canopy edge, the side comprising:
   a sheet material extending the length of the canopy for shielding weather (solar radiation, rain, wind, hail), and
   a venting region extending the length of the canopy comprising netting allowing air flow through the side of the canopy, the netting arranged alongside the sheet material to form a section of the side of the canopy, a longitudinal edge of the netting attached to a longitudinal edge of the sheet material,
   a venting region cover arranged over the venting region and the longitudinal edge of the sheet material for shielding weather and movable to allow the air flow through the side of the canopy, and
   a plurality of belts spaced apart along the longitudinal direction of the canopy, each belt extending across the venting region to reduce and limit the stretch of the venting region in a width direction of the canopy, an amount of stretch of the belts being less than an amount of stretch of the netting material without belts.

In some embodiments each belt comprises a strip or strap material attached to the sheet material or netting. In some embodiments the plurality of belts are integrally formed in the netting. In some embodiments the netting comprises venting portions and the plurality of belts, the venting portions comprising a first netting construction and the plurality of belts comprising a second netting construction, the second construction having less stretch than the first construction. In some embodiments the venting portions comprise a first construction density and the belts comprise a second construction density, and the second construction density is higher than the first construction density. In some embodiments the netting comprises a knitted construction, and venting portions comprise a first knitted density and the belts comprise a second knitted density, and the second knitted density is higher than the first knitted density. In some embodiments the belts comprise a different aperture shape to the venting portions. In some embodiments the netting comprises a knitted construction and the venting portions comprise one of a diamond, hexagonal and triangular aperture shape knit stretchable in the longitudinal and width directions of the canopy, and the belts comprise a pillar construction, pillars of the pillar construction aligned in the width direction of the canopy.

In some embodiments the canopy comprises securing features 44 near the canopy ridge line spaced apart along the canopy and the securing features are aligned with the belts in the width direction along the canopy.

In some embodiments the canopy comprises securing features near the canopy longitudinal edge spaced apart along the canopy and the securing features are aligned with the belts in the width direction along the canopy.

In some embodiments the venting region cover is secured to the side of the canopy along a longitudinal edge of the venting region cover above the venting region, and the canopy comprises a member that limits the amount the venting region cover may open or move away from the venting region of the canopy. In some embodiments the member is an elastic member for biasing the venting region cover towards a closed position over the venting region. In some embodiments the elastic member extends along the length of the canopy and is attached to the venting region cover and the side of the canopy at locations spaced apart along the length of the canopy. In some embodiments the elastic member is adapted to slide relative to the venting region cover and side of the canopy, and the length of the elastic member attached to the side of the canopy being adjustable. In some embodiments the elastic member is threaded through eyelets or loops attached to or formed with the venting region cover and the side of the canopy.

In some embodiments the canopy comprises a plurality of said elastic members spaced apart along the length of the canopy. In some embodiments, each elastic member is a rubber cord extending through an aperture on the venting region canopy and an aligned aperture in a side of the canopy.

In some embodiments the canopy comprises webbing members spaced apart along the length of the canopy, each member extending between the side of the canopy and the venting region cover, each webbing member comprising a folded strip of material.

In some embodiments the canopy comprises vent apertures. In some embodiments the canopy comprises a vent cover over each of the vent apertures.

In some embodiments the canopy comprises a reinforced centre lengthwise portion which has a heavier construction than the sheet material on either side of the reinforced centre portion, the venting region located between the reinforced centre lengthwise portion and the sheet material on at least one side of the canopy. In some embodiments the reinforced centre portion includes a double layer of sheet material, one said layer extending from the canopy to form the venting region cover.

In some embodiments the venting region is located alongside the ridge line of the canopy.

In some embodiments a join between the netting and the sheet material forms a flap, and one or more covering layer are folded over the outside of the flap.

In some embodiments the canopy comprises a longitudinal fixing flap comprising the sheet material a distance from a longitudinal edge of the canopy, the fixing flap comprising securing features spaced apart along the fixing flap, and a portion of the width of the canopy outside the fixing flap forming a cover portion. In some embodiments the longitudinal fixing flap is folded from a fold region of the sheet material along a longitudinal fold line at a distance from a longitudinal edge of the canopy, the fixing flap comprising at least two layers of the sheet material folded together. In some embodiments the fixing flap comprises a strip of material attached to the sheet material to reinforce the fixing flap, the securing features provided through the strip of material and the sheet material. In some embodiments the strip of material is provided to one side of the fixing flap. In some embodiments the strip of material is provided to both sides of the fixing flap with the sheet material sandwiched between. In some embodiments the fixing flap has a height of 35 mm to 150 mm. In some embodiments the fixing flap is formed 50 mm to 3 m from a longitudinal edge of the canopy so that the cover portion has a width of 50 mm to 3 m. In some embodiments the fixing flap is formed 50 mm to 2 m from a longitudinal edge of the canopy, or 50 mm to 1 m from a longitudinal edge of the canopy, or 300 mm to 500 mm from a longitudinal edge of the canopy so that the cover portion has a width of 50 mm to 2 m, or 50 mm to 1 m, or 300 mm to 500 mm. In some embodiments the canopy comprises two said fixing flaps, each fixing flap located a distance from a corresponding longitudinal edge of the canopy.

In some embodiments the fixing flap extends from the main portion of the canopy and the cover portion so that the cover portion extends from below the main portion of the canopy and from inside the securing features to form a curtain to hang below the main portion of the canopy in use. In some embodiments a join between the main portion of the canopy and the cover portion forms the fixing flap comprising at least two layers of sheet material.

In some embodiments the fixing flap extends from the main portion of the canopy and the cover portion so that the cover portion extends from above the main portion of the canopy and from inside the securing features to extend outside the longitudinal edge of the main portion of the canopy in use. In some embodiments a join between the main portion of the canopy and the cover portion forms the flap comprising at least two layers of sheet material so that in use the cover portion is folded along a longitudinal fold line to lie over the join and the securing features to extend outside the longitudinal edge of the main portion of the canopy. In some embodiments the cover portion comprises attachment features for securing the cover portion to an overlapping cover portion of an adjacent canopy or to a support structure or both in use. In some embodiments the attachment features comprise eyelets spaced apart along the length of the cover portion so that in use a member may be threaded through the eyelets and corresponding eyelets in the overlapping cover portion or through the eyelets and around a support structure or both.

In some embodiments the canopy comprises a lateral fixing flap comprising the sheet material a distance from a lateral edge of the canopy, the lateral fixing flap comprising securing features spaced apart along the lateral fixing flap, and a portion of the length of the canopy outside the lateral fixing flap forming a cover portion. The lateral fixing flap may comprise one or more features of the longitudinal fixing flap stated above.

In another aspect, in the invention comprises a method of sheltering a crop by positioning a canopy according to any one or more of the above statements over the crop.

In some embodiments, the method comprises positioning two or more said canopies side-by-side, each canopy comprising:
a longitudinal fixing flap comprising the sheet material a distance from a longitudinal edge of the canopy, the fixing flap comprising securing features spaced apart along the fixing flap, and a portion of the width of the canopy outside the fixing flap forming a cover portion, wherein
the fixing flap extends from a main portion of the canopy and the cover portion so that the cover portion extends from above the main portion of the canopy and from inside the securing features to extend outside the longitudinal edge of the main portion of the canopy, and
the cover portions of adjacent canopies overlapping.

The term “tape” or “tapes” is intended to include longitudinally extending single filament elements having four sides when viewed in cross-section, such as a rectangular or square cross-section, also longitudinally extending elements having a multisided cross-section such as a triangular or hexagonal cross-section for example, and also longitudinally extending elements having a circular or oval or similar cross-section (sometimes referred to hereafter as monofilament). The tapes may be formed from any suitable polyolefin such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA) and ethylene methyl acrylate (EMA) are useful for imparting elasticity and other properties. Polyesters and polystyrene, styrene-butadiene (SB), acrylonitrile-butadiene-styrene (ABS), styrene-acrylonitrile (SAN), polyethylene terephthalate (PET), polymethylmethacrylate (PMMA) and polycarbonate are useful as dye carriers and also for influencing radiation (reflecting, absorbing and transmission) properties and also other properties on the materials. Starch and other plant polymers are useful to increase biodegradability.

In at least some embodiments, the canopy, or at least the parts of the canopy that are outside the reinforced portion, are transparent or translucent to transmit light to plants beneath the canopy in use. By transparent or translucent we mean that the material may transmit at least 50% of solar radiation on average across the visible (wavelength about 400-700 nm) range. The material may optionally also transmit at least 10% on average across the UV (wavelength about 280-400 nm) and very near infrared (wavelength about 700-800 nm) ranges. The material may also optionally transmit at least 10% on average of solar radiation across the wavelength range about 800-2500 nm.

In some embodiments the material transmits at least 40%, at least 50%, at least 60%, at least 70%, at least 80% or at least 90%, of solar radiation on average across the visible (wavelength about 400-700 nm) range.

The term “netting” means a knitted, woven or non-woven material having a cover factor (as herein defined) of up to 80% but typically less than 70%, 60%, 50%, 40%, 30%, 20%, 10% or 5% or 2%.

The term “cover factor” means the percentage of the overall area of a netting material which comprises knitted, woven, or non-woven monofilament, yarn, or tape or a combination, forming the netting itself, judged from perpendicular to the plane of the netting when laid out flat, as opposed to air space in between the netting. Thus if a netting has a cover factor of 30% then the air space through the netting would be 70% of the total area of the netting.

The term “comprising” as used in this specification and claims means “consisting at least in part of”. When interpreting statements in this specification and claims which include the “comprising”, other features besides the features prefaced by this term in each statement can also be present. Related terms such as “comprise” and “comprised” are to be interpreted in similar manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

The invention is further described by way of example with reference to the accompanying drawings in which:

FIG. 1a is a schematic perspective view of the woven canopy material fixed over a central ridge of poles and spanning a ridge cable. The canopy material is translucent or partly translucent and the supporting structure can be seen through the canopy.

FIG. 1b is a schematic perspective view of the woven canopy material fixed over a central ridge of poles and spanning a ridge cable, and with vent apertures near the centre of the material. The canopy material is translucent or partly translucent and the supporting structure can be seen through the canopy.

FIG. 1c is a schematic perspective view of the woven canopy material fixed over a central ridge of poles and spanning a ridge cable, and with vent apertures near the centre, middle and edge of the material. The canopy material is translucent or partly translucent and the supporting structure can be seen through the canopy.

FIG. 1d is a schematic perspective view of the woven canopy material fixed over a central ridge of poles and spanning a ridge cable, and with vent apertures near the centre of the canopy and near the edge of the material.

FIG. 2 is side view of a canopy the same as the canopy of FIG. 1c but without reinforced areas in some regions of the canopy where vent apertures are provided.

FIG. 3a is an end view of the canopy of FIG. 1a.

FIG. 3b is an end view of the canopy of FIG. 1c with arrows indicating the flow of air passing from beneath the canopy to ambient air above the canopy via vent apertures in the canopy.

FIG. 3c is an end view of the canopy of FIG. 1c illustrating water running down an outside surface of the canopy and vent covers preventing water on the outside of the canopy from passing through the vent apertures.

FIG. 4a is a schematic cross section view of a section of a canopy to illustrate one possible construction.

FIG. 4b is a schematic cross section view of a section of a canopy to illustrate one possible construction.

FIG. 4c is a schematic cross section view of a section of a canopy to illustrate one possible construction.

FIG. 4d is a schematic cross section view of a section of a canopy to illustrate one possible construction.

FIGS. 5 and 6 show puncture damage to a prior art canopy caused by wear from a supporting pole.

FIG. 7a is a schematic cross section view of a section of a canopy to illustrate one possible construction.

FIG. 7b is a schematic cross section view of a section of a canopy to illustrate one possible construction with a centre flap and vent apertures on the same side of the canopy.

FIG. 8a is a part perspective view of the canopy of FIG. 1b.

FIG. 8b is a part perspective view of the canopy of FIG. 7b with a centre flap and vent apertures on the same side of the canopy.

FIG. 8c is a part perspective view of a canopy illustrating another form of vent cover over a vent aperture in the canopy.

FIG. 8d is a part cross sectional view of the canopy of FIG. 8c illustrating the vent cover billowing outwards.

FIG. 8e is a part perspective view of a canopy illustrating another form of vent cover over a vent aperture in the canopy.

FIGS. 8f to 8h are part cross sectional views illustrating vent covers formed from sheet material of different weights allowing differing rates of air flow through vent apertures.

FIG. 9 is a schematic perspective view of a canopy material fixed below a ridge cable supported by a support structure, and with vent apertures in the canopy near the centre, middle and edge of the material. The canopy material is translucent or partly translucent and the supporting structure can be seen through the canopy.

FIG. 10a is a part perspective view of a canopy material comprising a vent region of netting material adjacent a central region of the canopy.

FIG. 10b is a part perspective view of the canopy of FIG. 10a with a part of a cover covering the vent region lifted to show a portion of the vent region of netting material below the cover.

FIG. 11 is a part perspective view of a canopy material comprising a vent region of netting material adjacent a central region of the canopy with a cover over the vent region omitted to show the netting material. An enlarged view of a section of the venting region is included.

FIGS. 12a, 12b, 12c and 12d are cross section schematic views of a section of a canopy to illustrate possible constructions comprising a vent region with cover over the vent region.

FIG. 13a is a part perspective view of a canopy material comprising a vent region of netting material adjacent a central region of the canopy with a cover over the vent region and an elastic member for biasing the cover towards a closed position over the vent region. A portion of the cover is omitted to illustrate the venting region beneath.

FIG. 13b is a cross section schematic view illustrating an elastic member for biasing the cover over the vent region towards a closed position over the vent region.

FIGS. 13c and 13d are cross section schematic views illustrating a member extending between the cover over the vent region for limiting the amount the cover may open away from the venting region.

FIG. 14a is a part perspective view of a canopy material comprising a vent region of netting material adjacent a central region of the canopy with a cover over the vent region, and a longitudinal fixing flap located a distance from a longitudinal edge of the canopy for securing the canopy to a support structure. The portion of the width of the canopy outside the fixing flap may hang vertically to extend the covered area provided by the canopy.

FIG. 14b is a cross section schematic view of a canopy material comprising a longitudinal fixing flap located a distance from a longitudinal edge of the canopy for securing the canopy to a support structure. The fixing flap extends from the canopy so that the portion of the width of the canopy outside the fixing flap may hang vertically below the main portion of the canopy from inside of the fixing flap.

FIG. 14c is a cross section schematic view of a canopy material comprising a longitudinal fixing flap located a distance from a longitudinal edge of the canopy for securing the canopy to a support structure. The fixing flap extends from the canopy so that the portion of the width of the canopy outside the fixing flap extends from above the main portion of the canopy and from inside of the fixing flap.

FIG. 14d illustrates canopies according to the embodiment of FIG. 14B located side-by-side with curtain portions hanging from below the main portion of the canopy to extend the canopies effective area.

FIG. 14e illustrates canopies according to the embodiment of FIG. 14C located side-by-side with cover portions extending from above the main portion of the canopy and extending beyond a longitudinal edge of the main portion of the canopy, and the cover portions of adjacent canopies overlapping.

### DETAILED DESCRIPTION

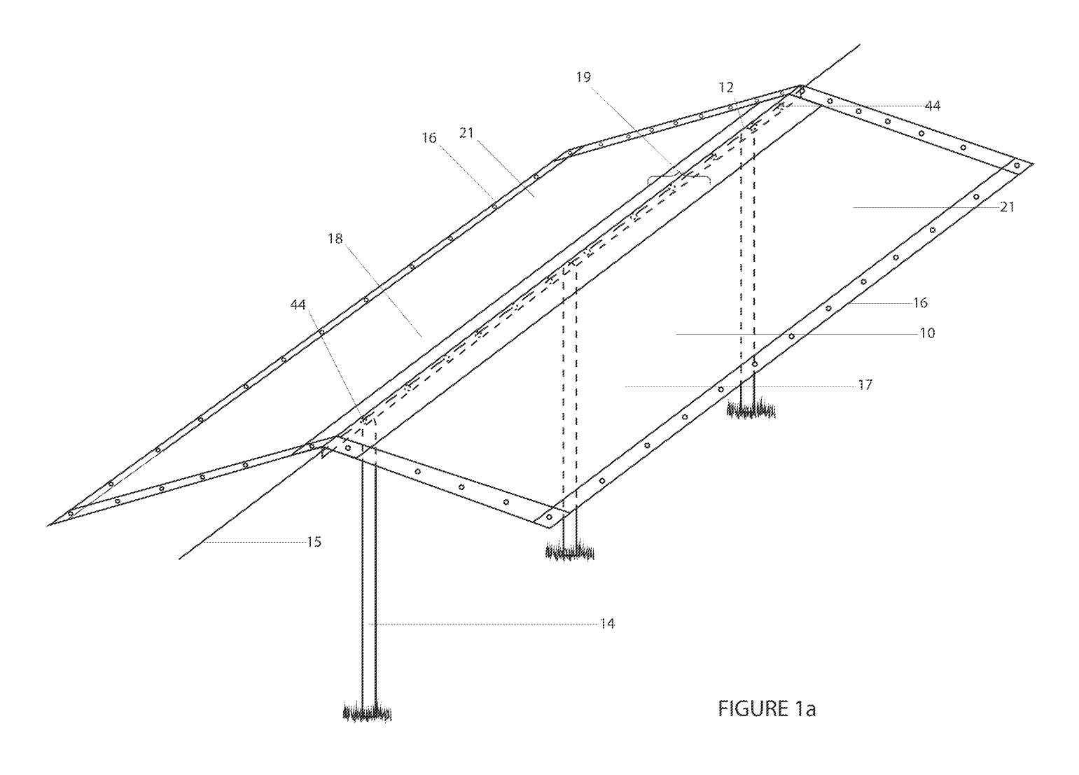

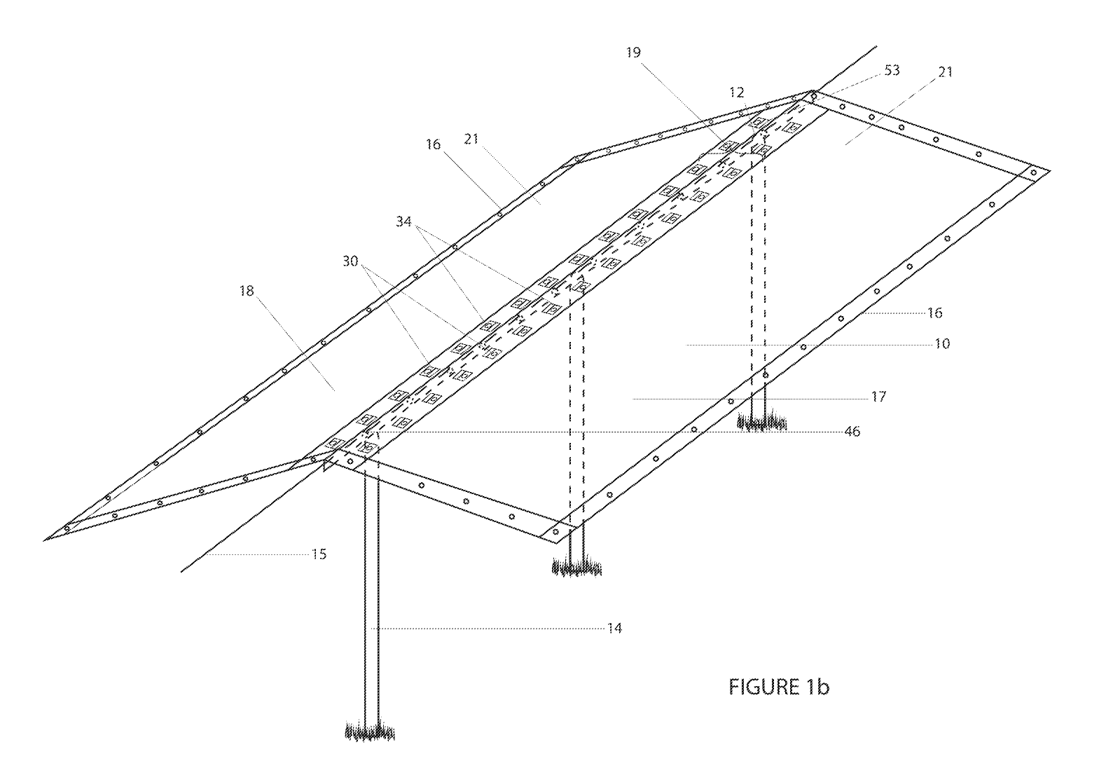

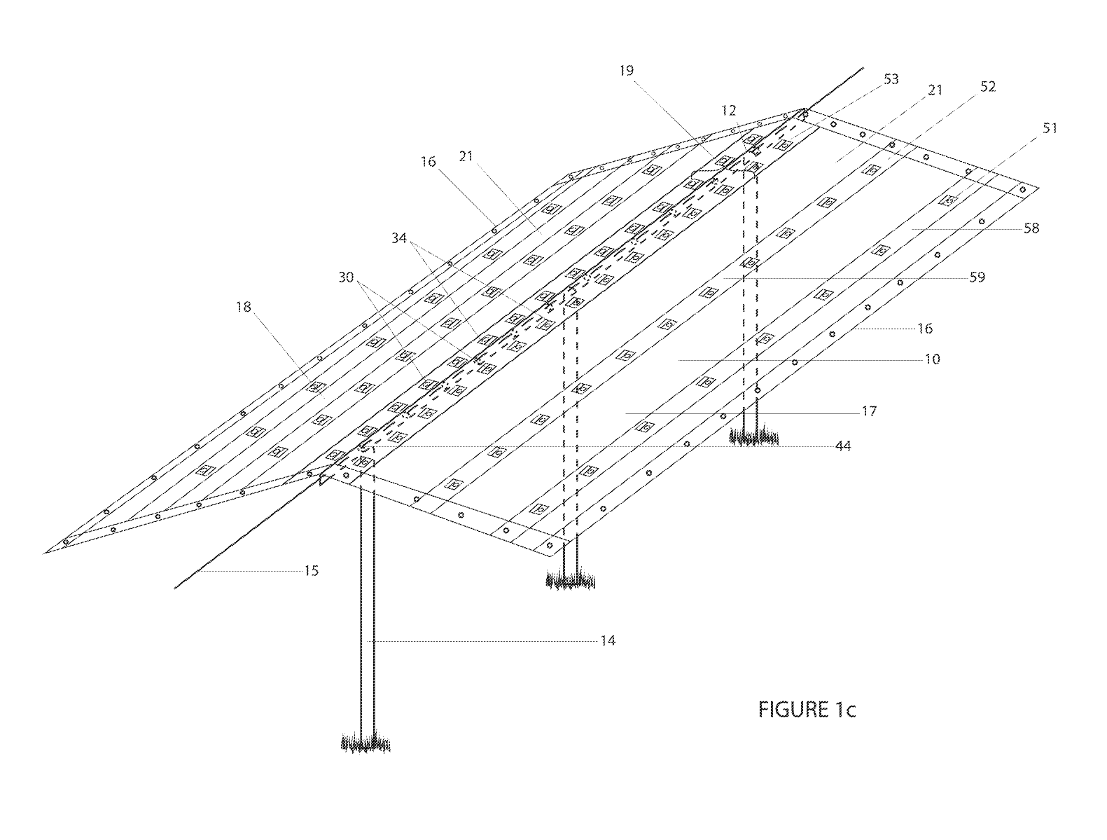

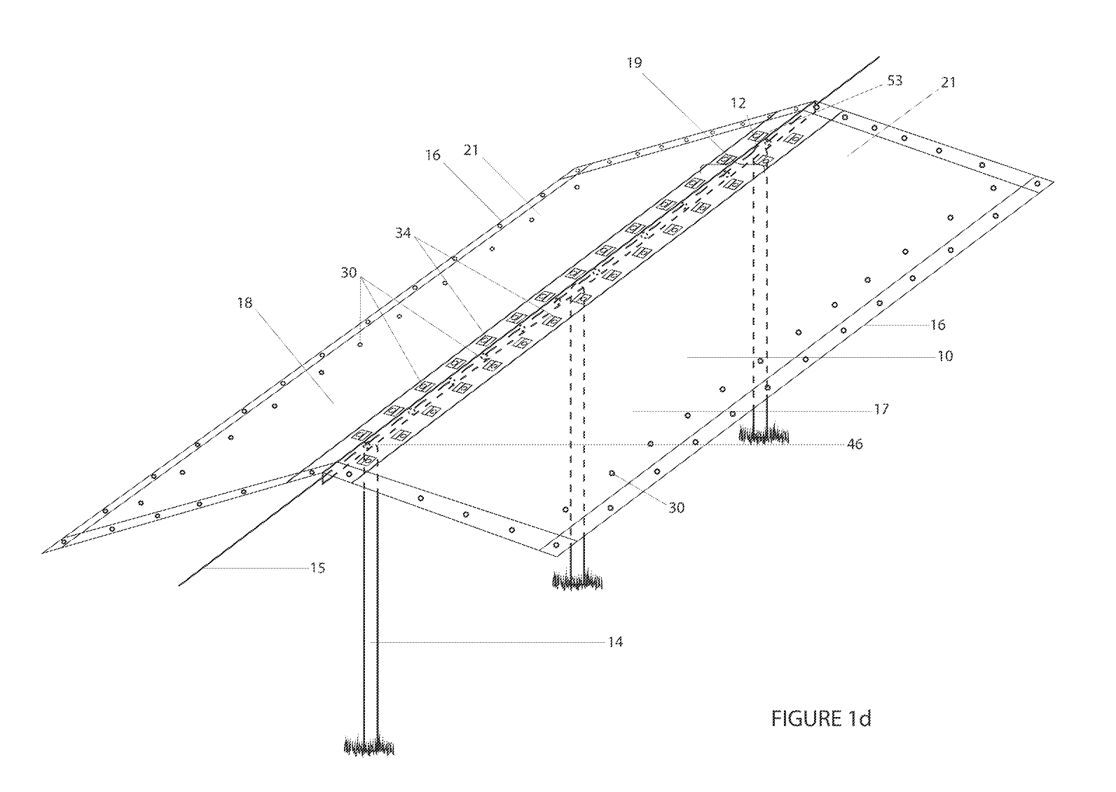

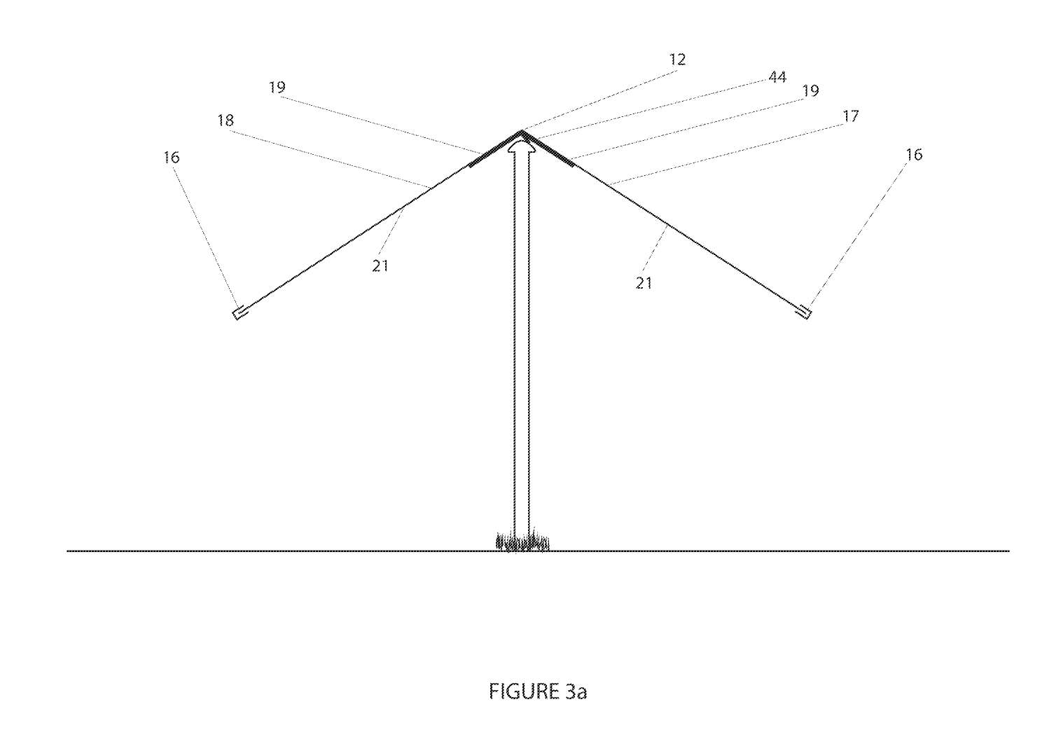

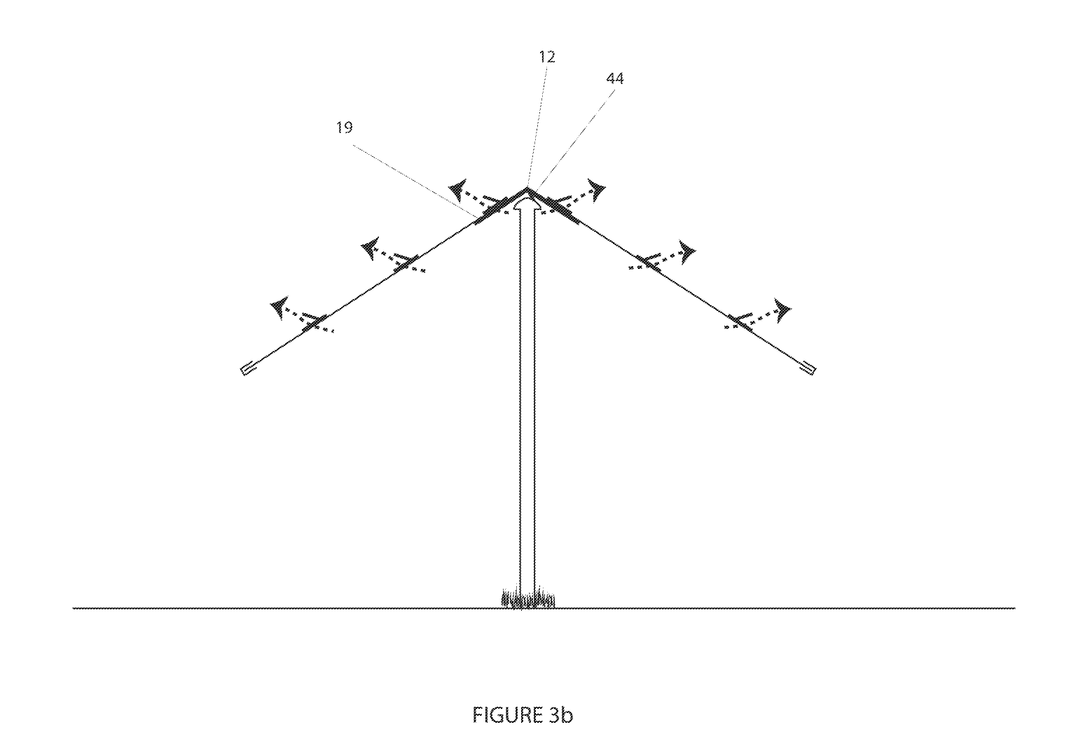

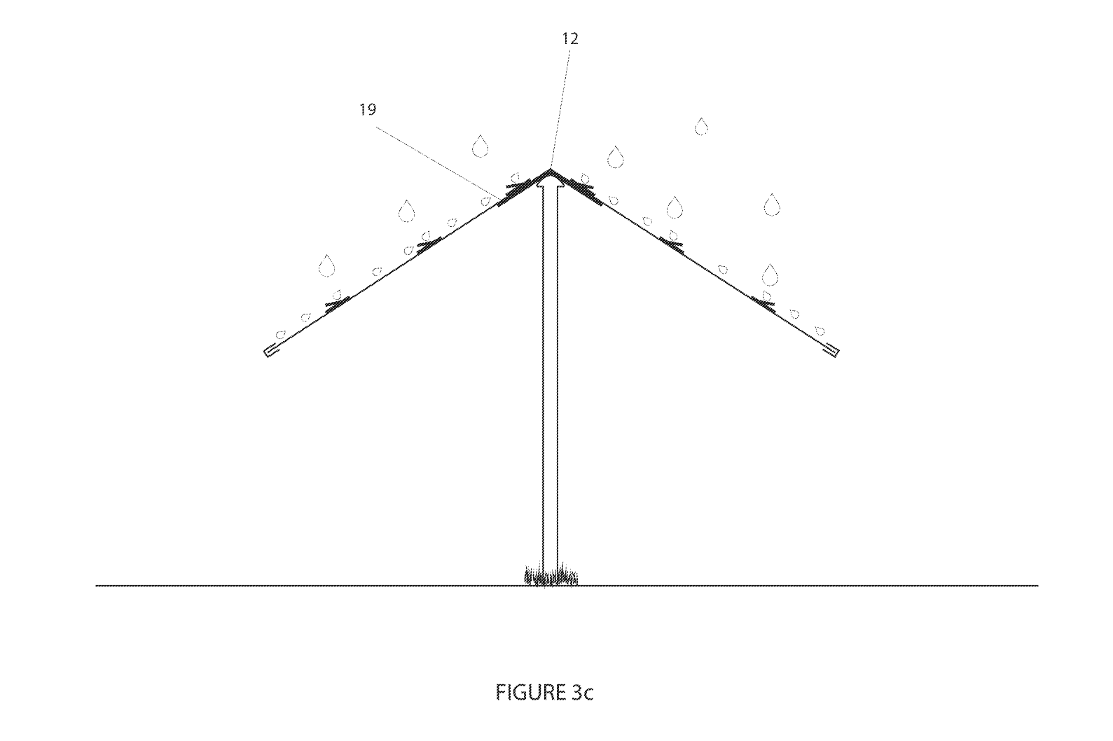

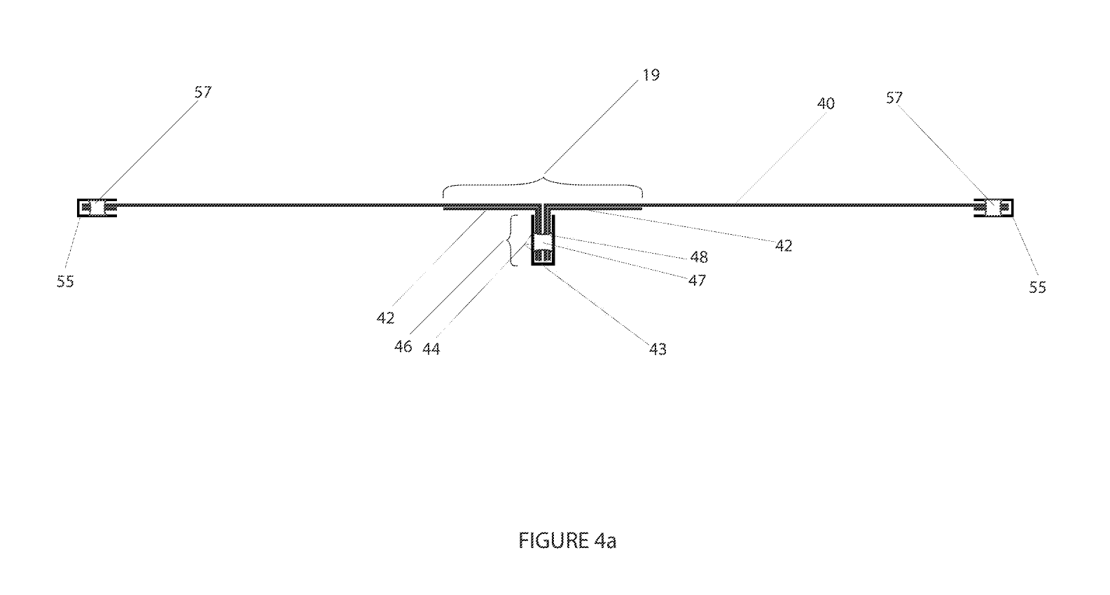

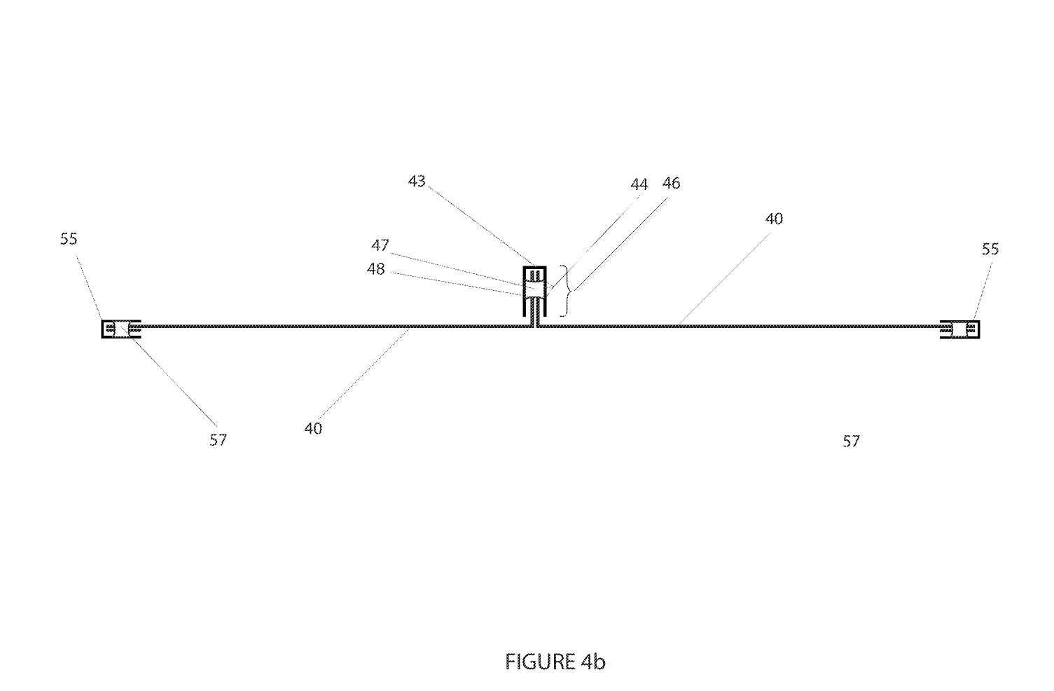

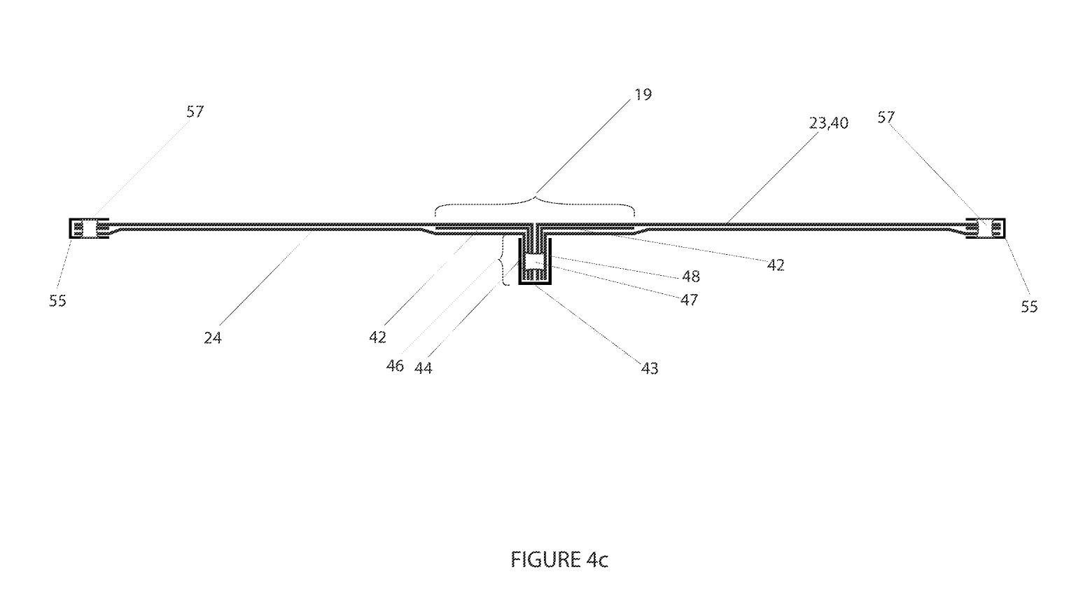

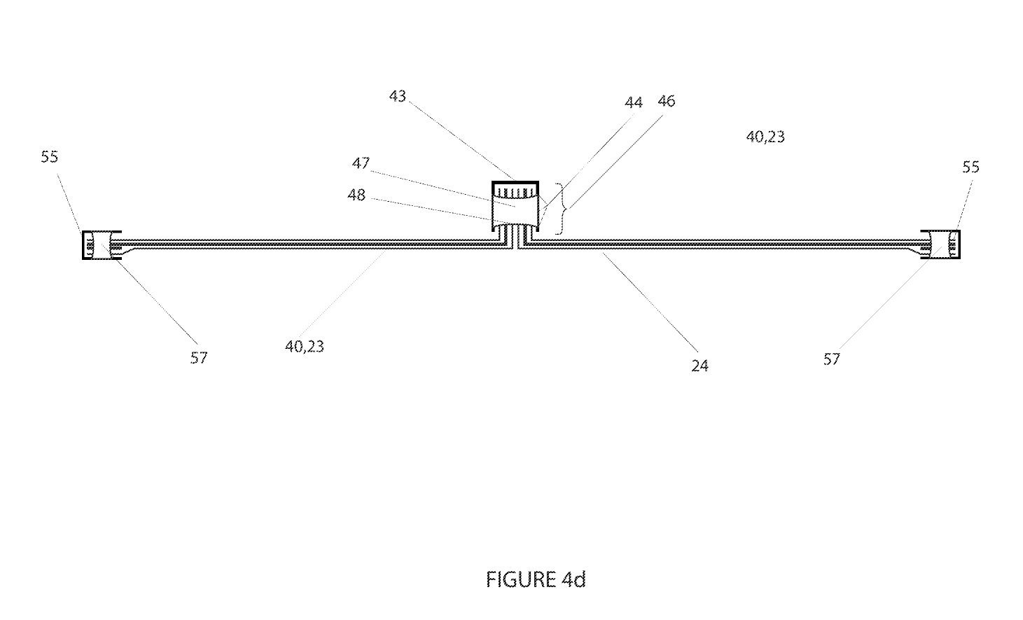

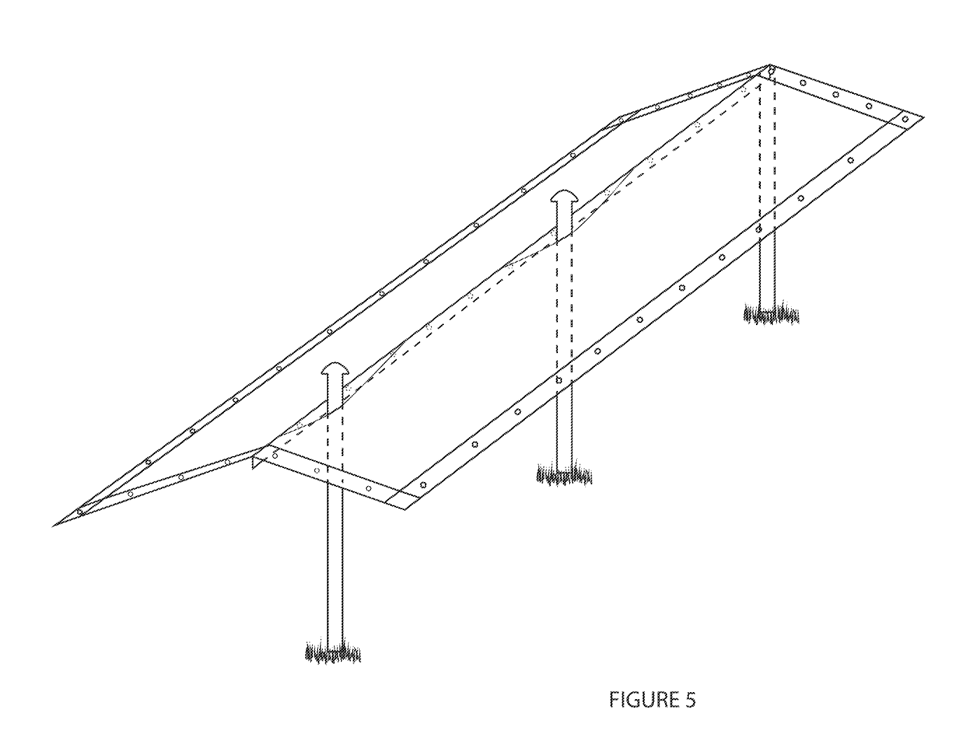

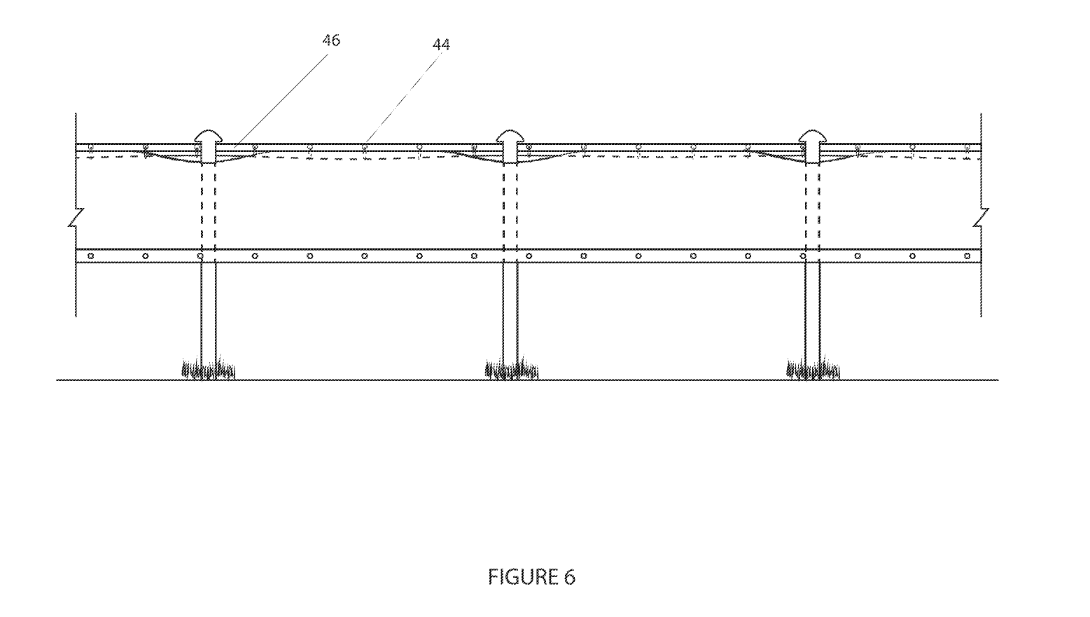

Referring to FIGS. 1 to 3 lengths of a canopy 10 (see FIG. 1) can be fixed over rows of for example berry vines or bushes. FIG. 4a shows a cross section of the canopy. Typically the canopy has a greater length than width, and is provided for use, as a roll or in concertina folded form. In use the canopy is supported along a ridge line 12 or peak by a combination of posts 14 and wires or cables 15 that extend between the posts. The case could be the canopy is attached to the wire under the canopy to 44 and the wire is supported by posts 14. Longitudinal edges of the canopy may be held in a stretched out condition by guys or fasteners connecting between the edge 16 of the canopy and any suitable securing point on the ground or on an adjacent frame or wire extending down the row length and/or across the row width. In this form the canopy forms a ridge with two major surfaces or side 17, 18 as shown in FIGS. 1 and 3 sloping away from the ridge line. The canopy is particularly intended for shedding water to provide partial shelter for the plants underneath. The canopy is particularly suited to use over ripening berry fruit or other fruits grown on trees. The canopy will typically remain in place for some months, before being removed and reused in a subsequent growing season or on another crop in the same growing season, but in some cases may remain in place over multiple growing seasons.

According to embodiments of the invention, the canopy comprises sheet material and has a reinforced centre lengthwise portion 19. The reinforced centre portion 19 has heavier construction than the material 21 on either side of the reinforced centre portion. The reinforced centre portion takes the line and point loading and associated wear from contact with the ridge line poles and wires that are underneath the material in FIG. 1a. This more durable portion has an increased life under the load and wear conditions than would be the case for the remainder of the material of the canopy. This increases the useful life of the canopy as a whole, without significantly increasing the overall shading from the canopy.

The sheet material may be woven from flat warp and weft tapes of a plastics material that could be later coated in plastic film on one or both sides; or not coated. Alternatively the sheet material could be plastics film. If the sheet material is woven from tapes, the tapes may be formed by extruding a film material from a polymer resin and then cutting the film into tapes which are in turn used to weave the material, or by extruding individual tapes. The tapes may be formed from a polymer containing pigments which give the canopy material desired properties, such as desired light reflective, absorptive, transmission and/or diffusive properties for example.

If a film the sheet material may be extruded so the reinforced centre lengthwise portion of the sheet material is extruded to be thicker than the other, and/or another layer of film may be welded, coated or sewn or similar to extruded film sheet to form the reinforced centre lengthwise portion.

In embodiments where the sheet material is woven from flat warp and weft tapes, the canopy may be woven with heavier warp tapes in the reinforced centre portion than outside the reinforced centre portion. For example, in some embodiments the warp tapes in the reinforced centre portion have a weight in denier that is at least 5% greater than the weight of the warp tapes outside the reinforced centre portion for a given tape width. In some embodiments the warp tapes in the reinforced centre portion have a weight in denier that is at least 10%, or 20%, or 30%, or 40%, or 50%, or 60%, or 70%, or 80%, or 90%, or 100% greater than the weight of the warp tapes outside the reinforced centre portion for a given tape width. For example, the sheet material of the canopy may be woven from warp and weft tapes comprising a nominal tape width of about 2 mm to 3 mm, or 2.4 to 2.6 mm and the warp tapes outside the reinforced portion may comprise a nominal weight of about 500 to 1400 denier, 900 to 1400 denier, or 1000 to 1300 denier, or 1100 to 1200 denier, or 1120 to 1160 denier and the warp tapes in the reinforced portion of the canopy may comprise a nominal weight of greater than about 1200 denier. In some embodiments, the warp tapes in the reinforced centre portion are 100% heavier than the weight of the warp tapes outside the reinforced centre portion for a given tape width. That is, the tapes in the reinforced portion are twice as heavy as the warp tapes outside the reinforced portion. For example, for a given tape width, the warp tapes outside the reinforced portion may comprise a nominal weight of about 1100 denier, and the warp tapes in the reinforced portion of the canopy may comprise a nominal weight of about 2200 denier. In some embodiments the weight of the warp tapes outside the reinforced portion is about 1000 to 1500 denier.

In some embodiments the warp tapes in the reinforced centre portion have a thickness that is at least 5% greater than the thickness of the warp tapes outside the reinforced centre portion. In some embodiments the warp tapes in the reinforced centre portion have a thickness that is at least 10%, or 20%, or 30%, or 40%, or 50%, or 60%, or 70%, or 80%, or 90%, or 100% greater than the thickness of the warp tapes outside the reinforced centre portion. For example, the warp tapes outside the reinforced portion may comprise a nominal thickness of about 55 microns, and the warp tapes in the reinforced portion of the canopy may comprise a nominal thickness of greater than about 60 microns. In some embodiments, the warp tapes in the reinforced centre portion are 100% thicker than the thickness of the warp tapes outside the reinforced centre. That is, the tapes in the reinforced portion are twice as thick as the tapes outside the reinforced portion. For example, the warp tapes outside the reinforced portion may comprise a nominal thickness of about 55 micron, and the warp tapes in the reinforced portion of the canopy may comprise a nominal thickness of about 110 micron. In some embodiments the thickness of the warp tapes on either side of the reinforced centre portion is 25 micron to 100 micron.

According to the illustrated embodiments, with particular reference to FIGS. 4a to 4d the canopy is constructed from at least one main web 40 of plastics sheet material (for example woven sheet material or unwoven sheet material). In some embodiments the main web of the canopy is constructed from a single layer of sheet material. The reinforced centre portion 19 comprises at least one additional material layer 42 secured to the main web.

The reinforcing layer may be fixed to the main web by any suitable means, such as bonding with adhesives or by heat, or by stitching, or an additional plastic coating or a combination of these methods. Preferably the additional material layer is heat bonded to the main web along lines or across areas or across substantially its entire area.

In some embodiments (FIGS. 4c and 4d) the main web sheet material 40 is woven from warp and weft tapes to form a woven sheet material 23, and comprises a coating layer 24 on one or both sides of the woven sheet material. A coating layer is in some embodiments on an outside or top side of the canopy. The coating layer is preferably a non-woven sheet material that is melted onto the woven sheet material. For example, the coating layer is an extruded sheet melted onto the woven sheet material to form a coating over the woven material. In some embodiments the coating layer material is the same as the material forming the warp and weft tapes for weaving the main web of the canopy. Preferably the coating layer, per side, weighs about 15 to 30 grams per square metre. The woven sheet material may comprise a weight of about 65 to 125 grams per square meter. In some embodiments the coating is LDPE (low density polyethylene). In some embodiments the tapes are HDPE (high density polyethylene). In some embodiments the coating and/or the warp and weft tapes comprise a UV stabilizer or stabilizers.

In some embodiments the additional reinforcing layer 42 has the same construction as the sheet material forming the main web of the canopy, comprising a woven sheet material with a coating layer. In some embodiments, the additional layer of sheet material is applied to the main web of the canopy with the coating layer of the reinforcing layer 42 facing downwards, and the coating layer of the main web of the canopy facing upwards. In such an embodiment the reinforced central portion of the canopy comprises a coating layer on the outside (top side) of the canopy, two layers of woven material (the main web 40 and additional layer 42), and a coating layer on the inside (underside) of the canopy.

In some embodiments the reinforcing woven layer and the main web material woven layer are arranged together with a coating layer on each of the two woven layers in contact. For example, where the woven sheet material has a coating on both sides, the coating layer on one side of the main web and the coating layer on one side of the reinforcing layer contact. Alternatively, where the woven sheet material has a coating on one side, the coating layer of the main web and the coating layer on the reinforcing layer may contact. Where the coating layers of the main web and the reinforcing layers contact, the coating layers may be melted together to join the main web and the reinforcing layers together. There may be at least some penetration of the coating layer through the woven sheet materials to hold the woven sheet materials together. The coating layer typically melts to the woven layers to hold the woven layers together. In some embodiments the upper and lower coating layers seals and holds or bonds the two layers of woven fabric together. For example, the coating layers are melted to penetrate and bond together the two woven layers. In some embodiments, in manufacturing the canopy, the woven main web and the woven reinforcing layer 42 are held or placed together, and a top coating layer is applied to a top surface of the woven main web and a bottom coating layer is applied to an under surface of the reinforcing layer (and in some embodiments to the remainder of the underside of the main web), so that the top and bottom coating layers join and hold or bond the layers of woven material together.

In some embodiments a coating layer is added to the main web and to the reinforcing layer before the main web and reinforcing layer are joined together. The coating layer may be an extruded sheet. The coating layer may cover the full surface of the main web. Alternatively, the coating layer may coat a portion of the width of the main web. For example, the coating layer may be in a strip or a plurality of spaced apart strips. For example, areas 58 and 59 may be coated portions of the main web of the canopy.

In some embodiments, the coat layer or layers may comprise chemical additives to impart particular properties to the canopy. For example, the coating material may comprise anti drip additives comprising a surfactant.

In some embodiments, the main web of the sheet material is woven from warp and weft tapes and the warp tapes in the reinforced centre portion have a greater weight and/or thickness than the warp tapes on either side of the reinforced centre portion, and the reinforced centre portion may in addition also comprises at least one additional material layer 42 secured to the centre portion of the main web which may also comprising the heavier warp tapes.

In the illustrated embodiments the canopy includes securing features 44 within the region of the reinforced centre portion 19. In particular the canopy includes a flap 46 extending from the reinforced centre portion. At least one securing feature 48 is located in or on the flap. The flap extends for substantially the whole, or at least a majority, of the length of the canopy. In some embodiments a series of independent flaps may be provided dispersed along the length of the canopy.

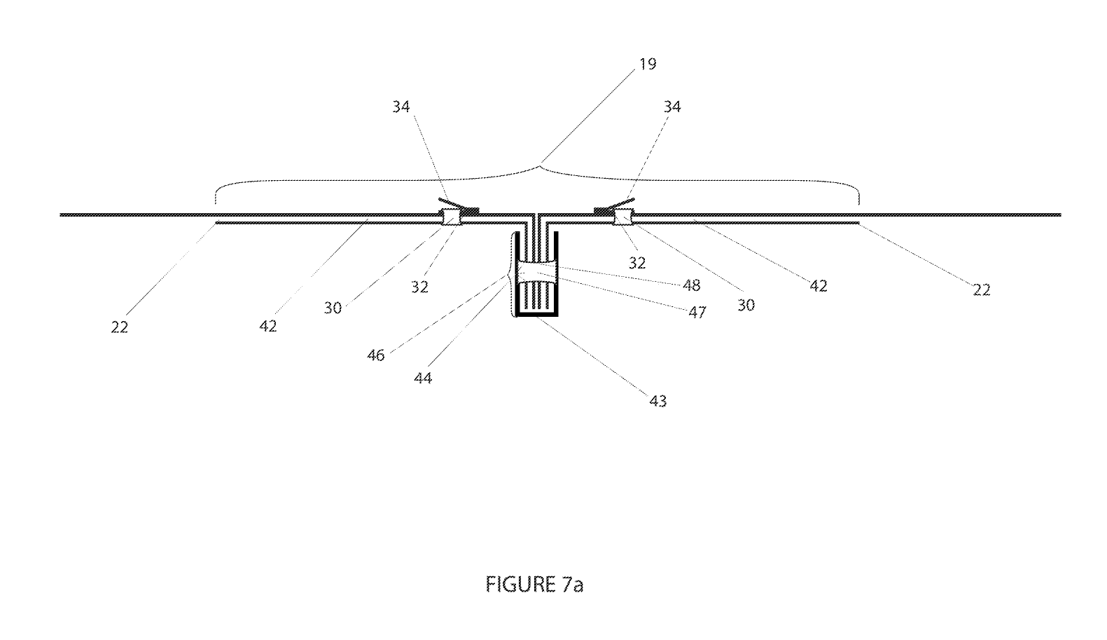

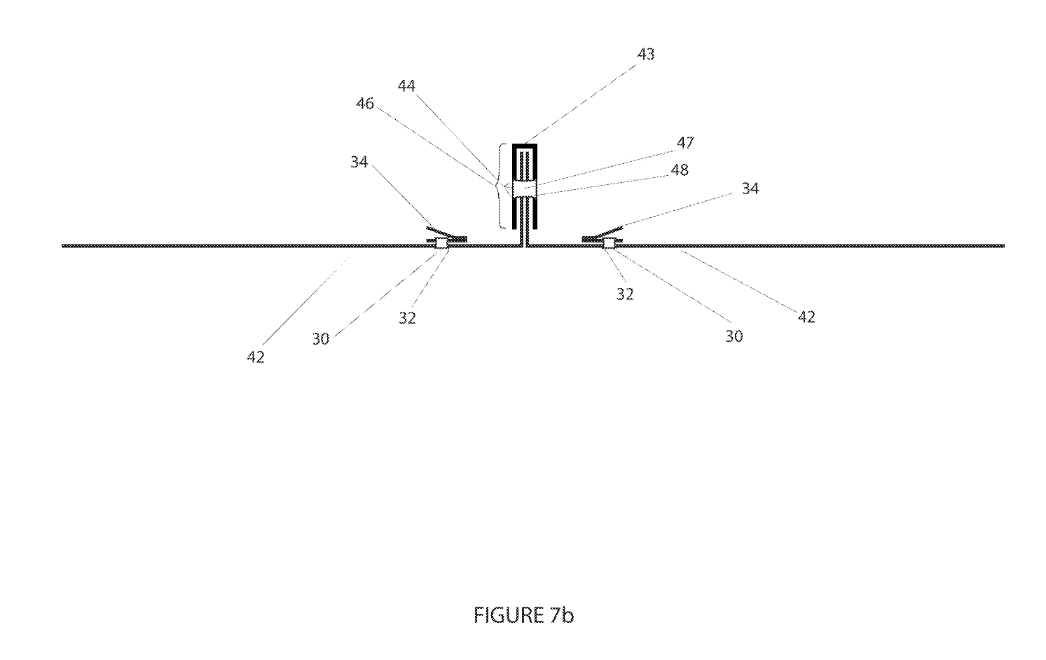

In the illustrated embodiment the flap 46 in FIGS. 4a and 7a is developed by an extension of the web 40. The web 40 may be constructed from two parts, with edge portions of the two parts secured together by heat sealing, adhesive bonding or sewing. The secured edge portions form the flap 46. As described above, in some embodiments the web sheet material 40 may comprise a coating on one or both sides. In such embodiments, the coating layer(s) is also formed into the flap together with the woven sheet material. For example, the flap may comprise a coating layer on a first side of the flap, two layers of woven material separated from another two layers of woven material by two coating layers, and another coating layer on an opposite second side of the flap. One or more extra material layers may be included in the flap. For example a covering layer 43 in FIGS. 4a, 4b and 7a, 7b of material may be folded over the outside of the flap and be heat bonded, adhesively bonded or sewn to the flap.

In the illustrated embodiment, at least one securing feature is an aperture 47 (FIGS. 4a and 7a) in the flap. The aperture may be provided with reinforcing such as a plastic or metal eyelet or grommet such as 48 in FIGS. 4a and 7a.

Alternatively the securing feature might be a hook or clip or tag line bonded or sewn to a flap, or bonded or sewn directly to the reinforced centre portion of the canopy.

In the illustrated embodiment the flap comprises at least one layer of the main web of canopy material. The flap illustrated comprises two layers of the main web of canopy material bonded together. The flap may be folded from the web sheet material to form two layers joined at a fold. In the illustrated embodiment the two layers each end at an edge at the edge of the flap, the main we formed from two parts as described above.

The additional material layer of the reinforced centre portion of the canopy may be provided into the flap as well as adjacent the flap, as illustrated in FIG. 4a. Alternatively, the additional material layer of the reinforced centre portion of the canopy is provided only adjacent to the flap, so that a separate web of reinforcing material is provided at either side of the flap 46.

The flap may be provided with one or more additional reinforcing layers. For example an edging tape or strip or belt of material 43 may be folded over the outside of the flap as illustrated in FIG. 4a. The edging tape or strip or belt of material may be secured in any suitable fashion such as stitching, adhesive or heat bonding. The edging tape may be sufficiently wide to substantially cover both faces of the flap.

In other embodiments the flap may comprise a fold of the reinforcing sheet material, such that the reinforcing sheet material forms a double layer as the flap, and extends away from the flap on either side where the flap joins to the main web of the canopy. The double layer of the flap may be heat bonded together or sewn along one or more lines to secure the two layers together.

In some embodiments the longitudinal centre portion of the canopy is not reinforced, as illustrated in FIGS. 4b and 7b. As illustrated in FIGS. 4b and 7b, the flap 46 may comprise two layers of the sheet material that forms the main web of the canopy. However, in some embodiments, the flap 46 may include additional layers of reinforcing material. For example, the flap in FIGS. 4a and 7a may comprise the same construction as the flap in FIG. 4a, however, the additional reinforcing layer 42 is applied in the flap 46 only and does not extend into the central portion of the canopy so that the central portion is not reinforced by the reinforcing layer 42.

The flap may comprise additional layers of material, for example one or more reinforcing members may be located and secured within or over the folded double layer, or the single sheet of reinforcing material may include multiple folds to form a flap with multiple stacked layers.

In use, the securing features located within the area of the reinforced portion of the canopy are connected to the supporting ridge wire or to the supporting poles. This ensures that the reinforcing centre portion of the canopy stays in position over the ridge wire and/or supporting poles.

In at least some embodiments, the canopy, or at least the parts of the canopy that are outside the reinforced portion, or just the reinforced portion, are transparent or translucent to transmit light to plants beneath the canopy in use. By transparent or translucent we mean that the material may transmit at least 50% of solar radiation on average across the UV (wavelength about 280-400 nm), visible (wavelength about 400-700 nm) and very near infrared (wavelength about 700-800 nm) ranges, and which transmits at least 10% on average of solar radiation across the wavelength range about 800-2500 nm.

The canopy may also include UV absorbers to reduce the amount of UV that is part of the transmitted light below the canopy for the benefit of the plants below the canopy.

In some embodiments the sheet material of the canopy is white in colour. The sheet material may alternatively be another colour such as red or green or blue or silver, or be clear.

In some embodiments the reinforced centre portion 19 of the canopy has a width of between 3 to 50 cm, or 5 to 30 cm or 5 to 20 cm, and the overall width of the canopy is between 1-12 metres, or 1.5 to 6 metres, or 2 to 5 metres or 2.5 to 3.5 metres, or 2.8 to 3.2 metres for example.

Edges of the canopy may include fastening features. For example the canopy may include a reinforced edge 55 and a plurality of spaced apart fastening locations, such as rings, hooks or eyes (as at 57) or apertures located in the reinforced edge. Reinforced edges may be provided by bonding a folded edge tape over the edge of the main web of the canopy.

The material of the main web of the canopy may have a tight weave or high weave density so that the canopy has low or negligible water permeability. Additionally or alternatively the web may be coated with a continuous coating of a plastics material for example by extrusion coating at manufacture of the material. Alternatively again the material may be heat treated to melt or partially melt bond the warp and weft tapes together to be water impermeable.

Preferably securing of additional layers of material, such as for reinforcing the centre portion, or for reinforcing the edges of the material, is by methods that are non-piercing of the material, such as heat bonding, or by pressed together the two layers then coating on the outside of the two layers, on the up (top) side and on the down side, two layers of coating, to seal and hold the two layers of woven fabric together. So preferably the securing is not by stitching.

In some embodiments the material may incorporate a compound or compounds added to eliminate or reduce the extent to which the material forms water droplets of, for example, condensation. The anti drip additives may comprise, for example, a non-ionic surfactant. The anti drip additive may be included in coatings applied to a woven substrate, or in polymer tapes of the woven substrate.

As stated the tapes may be formed from a polymer containing pigments which give the canopy material desired properties, such as desired light transmission properties for example. Some or all tapes of a reflective material may be formed from a resin comprising a white pigment, which resin has been formed by mixing a masterbatch consisting essentially of 1 to 90% by weight of a white pigment or combination of pigments chosen from zirconium, strontium, barium, magnesium, titanium, zinc and calcium pigments, and a first polymer, with a second polymer such that the resin (masterbatch) comprising the white pigment comprises between about 1 to 50% by weight of the total mixture. In certain embodiments the white pigment may be selected from zirconium dioxide, magnesium zirconate, calcium zirconate, strontium zirconate, barium zirconate, zirconium silicate, zinc sulphide, calcium carbonate, barium sulphate, magnesium oxide, strontium carbonate, barium carbonate, titanium dioxide, zinc oxide and potassium titanate.

In some embodiments the canopy 10 comprises vent apertures 30 in the reinforced centre region 19 of the canopy 10, illustrated in FIGS. 1b, 1c, 1d, 7a, 7b and 8a. The vent apertures 30 may allow hot or warm air beneath the canopy to escape from beneath the canopy to ambient air above the canopy. The vent apertures 30 may also allow higher air pressure beneath the canopy, caused by such things as wind to escape to lower air pressure above the canopy. In some embodiments the vent aperture may include a reinforcing grommet or eyelet 32. In some embodiments, a vent cover 34 is provided over each vent aperture. The vent cover or flap 34 restricts water from flowing or entering the vent aperture and passing from outside the canopy to inside the canopy but allows air to move upwards though the vent.

In the illustrated embodiment, a separate vent cover 34 is provided at each vent aperture 30. In other embodiments, a continuous cover or flap extending longitudinally along the canopy may cover more than one vent aperture 30. In some embodiments the vent cover has a width of about 4 cm to 14 cm. In some embodiments the vent apertures have a diameter of less than about 100 mm. In some embodiments the vent apertures have a diameter of about 60 mm, 50 mm, 40 mm, 35 mm, 30 mm, 25 mm, or 20 mm, or 15 mm, 12 mm, or 10 mm.

In some embodiments the vent apertures are provided to the reinforced centre portion 19 of the canopy. In some embodiments the vent apertures are provided near to or adjacent to the centre or ridge line 12 of the canopy. In some embodiments the vent apertures are positioned at about a midpoint between an edge 22 of the reinforced centre portion 19 and the flap 46 comprising securing features 44. For example, in an embodiment where the reinforced portion is 30 cm wide, the vent aperture is located at about 8 cm from the centre of the reinforced portion 19, or 8 cm from the flap 46 comprising the securing features 44. In some embodiments, the vent apertures are closer to the centre of the canopy than the edge 22 of the reinforced portion 19 of the canopy. For example, in an embodiment where the reinforced portion is 30 cm wide, the vent aperture is located at about 3 cm to 4 cm from the centre of the reinforced portion 19, or 3 cm to 4 cm from the flap 46 comprising the securing features 44. In some embodiments the vent apertures are located about 5 cm to 20 cm, or from 7 cm to 13 cm, or 8 cm to 12 cm, or 9 cm to 11 cm, or about 10 cm from the centre 12 of the canopy. In some embodiments, the vent apertures are placed at or adjacent to the edge 22 of the reinforced centre portion 19. In some embodiments, the vent apertures may be placed adjacent to the ridge line or flap 46 of the canopy.

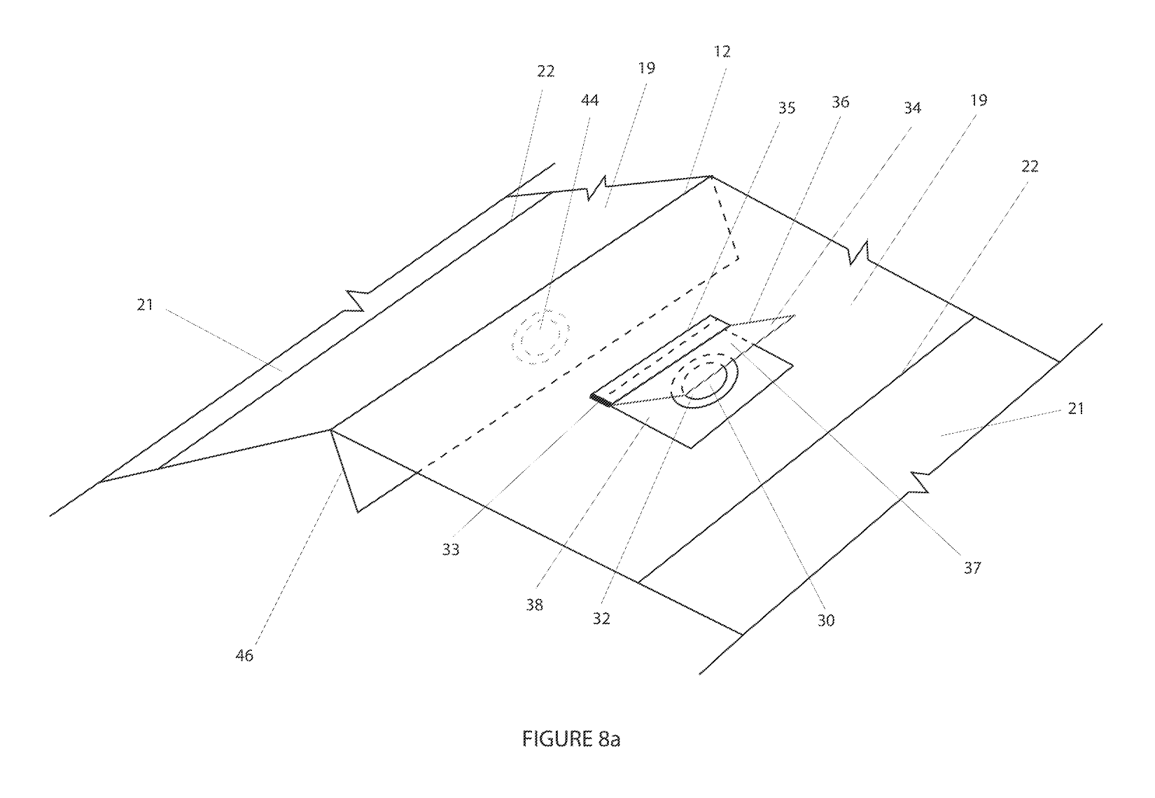

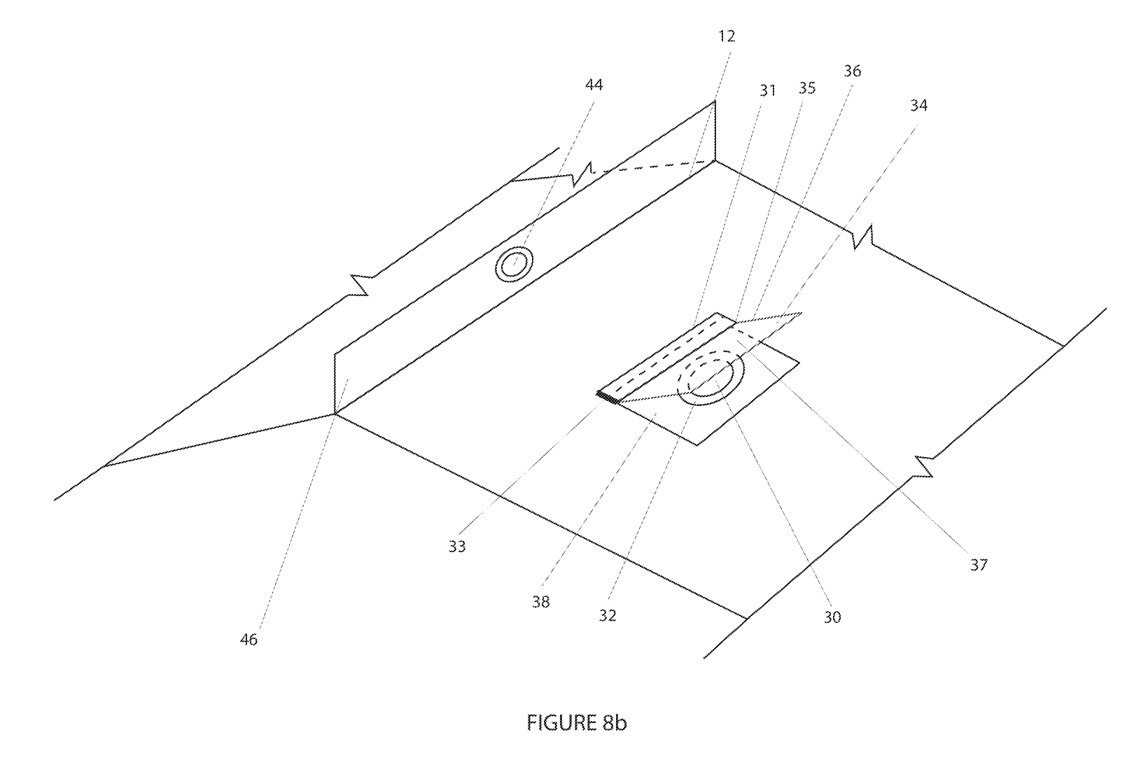

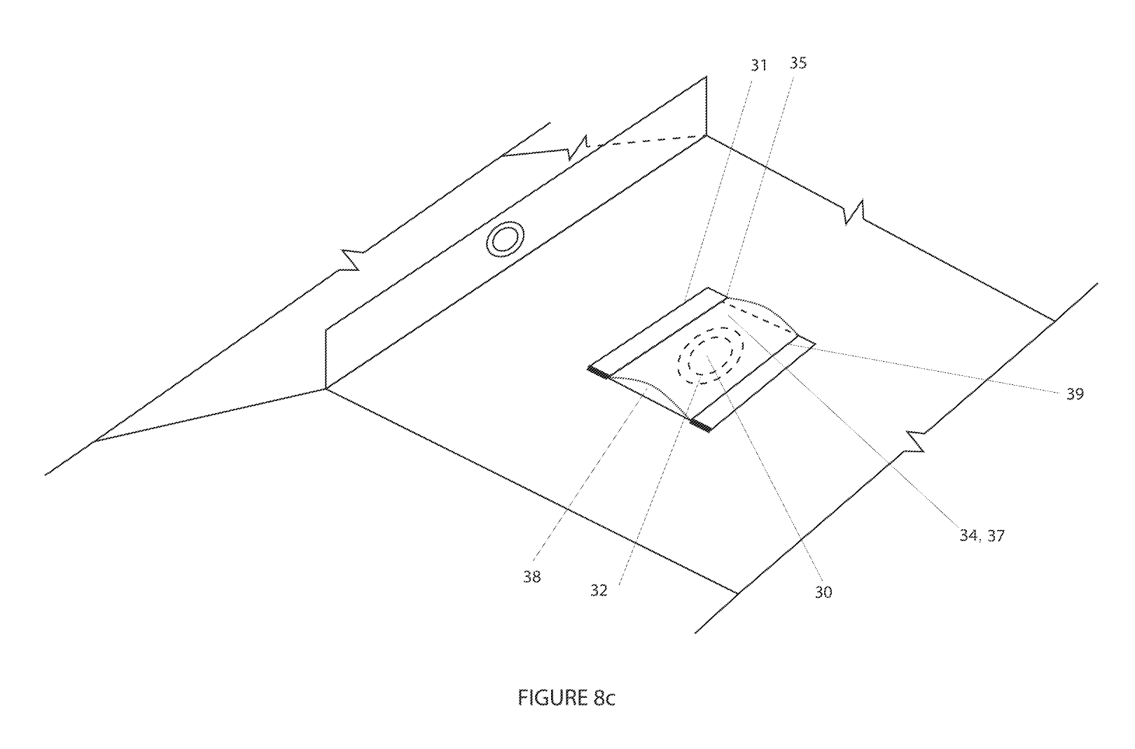

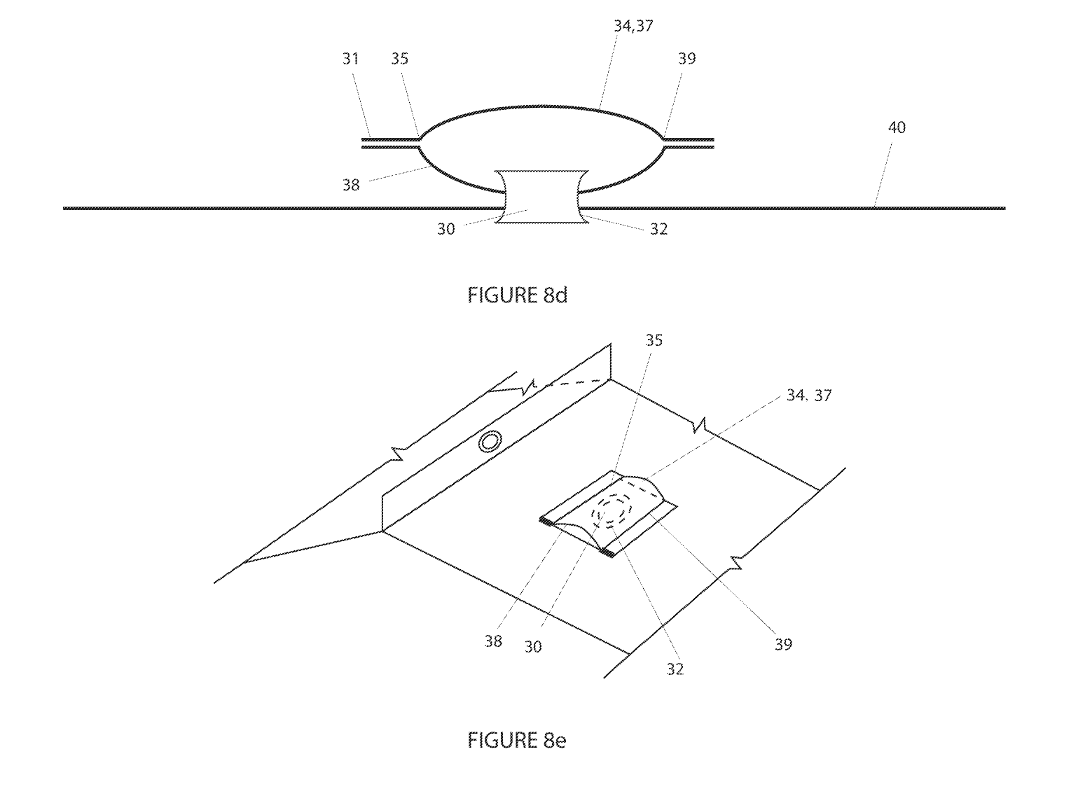

The vent cover 34 may be attached to the reinforced portion of the canopy at or adjacent to a longitudinal edge 35 of the vent cover that is positioned above the vent aperture in use. The vent cover 34 may be attached to the reinforced portion of the canopy at or adjacent to a longitudinal edge 35 of the vent cover that is located between the ridge line 12 of the canopy and the vent aperture 30. The vent cover may be fixed to the reinforced portion by any suitable means, such as bonding with adhesives or by heat, or by stitching (33 in FIGS. 8 and 8b), or a combination of these methods. In use, water is restricted from entering the vent aperture by the cover 34.

In some embodiments, a lateral side or sides 36 of the vent cover may be attached to the canopy reinforced portion 19, in part or in full, to reduce any side way entry of water under the vent cover.

The vent cover may be formed from a piece or strip of material. The vent cover material may be woven from flat warp and weft tapes of a plastics material or woven from flat warp and weft tapes of a plastics material that has later been coated on one or both sides. Alternatively the cover material could be plastics film. In some embodiments the vent cover is formed from the same sheet material as the canopy sides. In the illustrated embodiment of FIGS. 8a and 8b, the vent cover 34 is formed from a folded piece of sheet material. The sheet material of the vent cover is folded about a fold line 31. An outer side 37 of the sheet material of the vent cover forms the vent cover 34. An inner side 38 of the sheet material is attached to the reinforced portion of the canopy. For example, in some embodiments, the vent aperture may include a reinforcing grommet or eyelet 32, and the inner side 38 of the vent cover sheet material is attached to the canopy by the grommet or eyelet extending through the inner side 38 and the canopy. In some embodiments, the inner side of the vent cover material may be attached to the canopy around a perimeter of the vent aperture by bonding with adhesives or by heat, or by stitching, or a combination of these methods. In some embodiments the vent cover is formed from a material that is formed in a cylinder. The cylinder is flattened or folded to form the inner side 38 and the outer side 37, the vent aperture 30 being formed through the inner side, and the outer side of the cylinder of material forming the vent cover 34 over the vent aperture.

In some embodiments the outer side or vent cover 34 is attached to the inner side of the strip or cylinder of material along a longitudinal edge 35 of the vent cover above the vent aperture relative to a ridge line of the canopy. For example, the outer side may be bonded with adhesive or by heat, or by stitched to the inner side. In some embodiments at least an upper portion of a lateral side or sides 36 of the vent cover may be attached to the inner side of the strip or cylinder of material to help restrict the amount the vent cover lifts away from the venting aperture. In some embodiments the inner side of the strip or cylinder of material is only attached to the canopy main web or sheet material around the aperture 30, for example by a grommet 32 around the vent aperture.

The inner side of the material of the vent cover provides reinforcement to the vent aperture. For example, in some embodiments, the canopy comprises three layers of material at the vent aperture; the main web of the canopy 40, an additional material layer 42 for reinforcing the centre region 19 of the canopy, and the inner side 38 of the vent cover sheet material. In some embodiments the vent cover is provided without an inner side 38 so that the vent aperture is formed through the reinforced portion of the canopy and without further reinforcement provided by the additional layer of an inner side 38 of the vent cover sheet material.

In FIG. 8 the vent cover 34 is illustrated in a folded out position. In some embodiments, in use the vent cover 34 may lie flat against the vent aperture 30.

In the embodiment illustrated in FIG. 1b, the vent apertures 30 are located adjacent to a securing feature 44 along the length of the canopy. In the illustrated embodiment, the vent apertures are located at alternate sides of the ridge 12 along the length of the canopy. In the embodiment of FIG. 1b, the vent apertures on each side of the ridge 12 are aligned. In some embodiments, as shown in FIG. 1d, the vent apertures on one side (first side) of the ridge 12 are staggered with the vent apertures on the other side (second side) of the ridge.

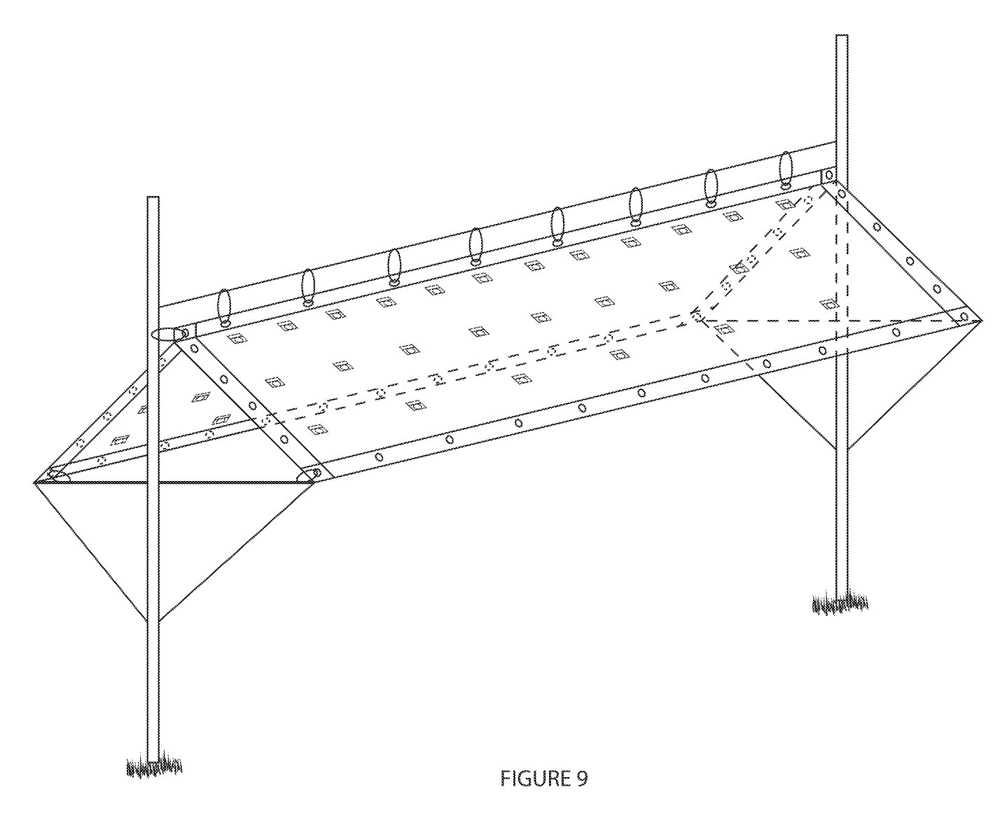

In some embodiments the canopy comprises vent apertures 30 without a reinforced area in the centre part of the canopy. For example, in the embodiments illustrated in FIGS. 4b, 7b and 8b, the canopy is provided with a flap 46 comprising securing features 44. The flap 46 extends above the canopy to secure the canopy from above the canopy, for example by a wire extending through the securing features 44. In the embodiments of FIGS. 4b, 7b and 8b, the canopy is hung from the securing features 44 and the centre portion of the canopy may not rest on ridge line poles. Such a canopy may not comprise a reinforced central portion. An example canopy comprising an outwardly extending flap with securing features and a support structure for supporting such a canopy is provided in FIG. 9.

In an embodiment without a reinforced portion, the vent apertures 30 may be located in a longitudinally extending centre region of the canopy to be near to or adjacent the centre of the canopy. For example the vent apertures may be at about 7 cm to 13 cm, or 8 cm to 12 cm or 9 cm to 11 cm or about 10 cm from the centre 12 of the canopy. The vent apertures may comprise a vent cover as described above. For example, the canopy may comprise two layers of material at the vent aperture; the main web 40 of the canopy and the inner side 38 of the vent cover material. In some embodiments the vent cover is provided without an inner side 38 so that the vent aperture is formed through the main web 40 of the canopy and without further reinforcement provided by the additional layer of an inner side 38 of the vent cover material.

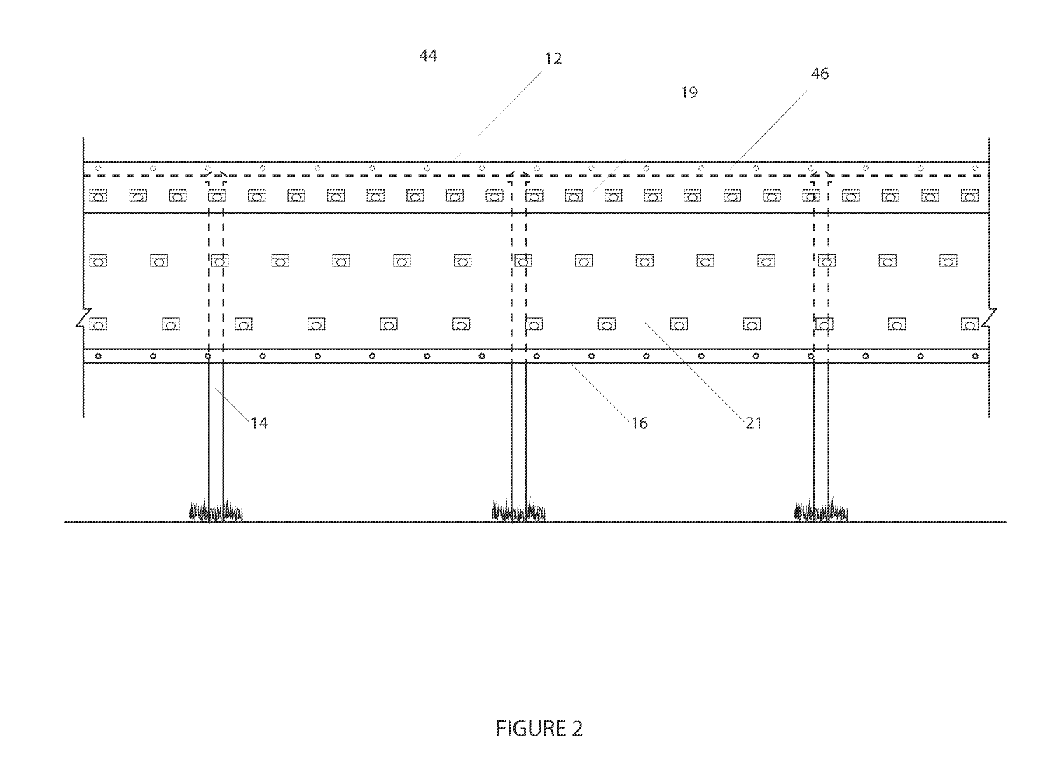

In some embodiments, vent apertures are provided outside a centre portion 19 of the canopy, for example as illustrated in FIGS. 1c and 2. For example, the canopy may comprise vent apertures 30 located in a longitudinal extending edge region of the canopy to be positioned towards or near to a longitudinal edge of the canopy 10. For example, a longitudinal row or group 51 of vent apertures may be positioned 5 cm to 50 cm, or 5 cm to 30 cm, or 5 cm to 20 cm, or about 10 cm from a longitudinal edge of the canopy (referred to herein as an edge region of the canopy). However, the apertures in the edge region may not be aligned in a row.

In some embodiments the canopy may comprise vent apertures 52 located in a longitudinally extending intermediate region of the canopy between a centre 12 or centre region or ridge of the canopy and a longitudinal edge or edge region of the canopy. For example, the canopy may comprise a longitudinal row or group of vent apertures 52 located approximately midway between a centre 12 of the canopy and a longitudinal edge of the canopy. For example, for canopies that are 1 m to 10 m wide, the midpoint for the longitudinal extending intermediate region would be 0.25 m to 2.5 m from the longitudinal edge of the canopy. In some embodiments the longitudinally extending intermediate region of the canopy is between 5 cm from a longitudinal edge of the canopy and 10 cm from a centre 12 of the canopy. In some embodiments the longitudinally extending intermediate region of the canopy is between 10 cm from a longitudinal edge of the canopy and 15 cm from a centre 12 of the canopy. In some embodiments the canopy comprises vent apertures 50 cm to 200 cm, or 50 cm to 150 cm, or 50 cm to 100 cm from a longitudinal edge of the canopy. The apertures may not be aligned in a row.

In some embodiments, the canopy comprises more than one longitudinal row or group of vent apertures. For example, a canopy may comprise more than one of a longitudinal row or group 51 of vent apertures located towards or near to a longitudinal edge of the canopy 10 (referred to herein as an edge region of the canopy), a longitudinal row or group of vent apertures 52 located approximately midway between a centre 12 of the canopy and a longitudinal edge of the canopy, and a longitudinal row or group of vent apertures 53 located near to or towards a centre 12 of the canopy. The vents could also be placed randomly in each side of the canopy so they are not in a distinct pattern or in rows.

As described above, in some embodiments the canopy comprises vent apertures in the centre portion 19 (that is reinforced or not reinforced) of the canopy, and also vent apertures outside the centre portion, for example rows of vent apertures 51 and 52. In some embodiments, the canopy sheet material is reinforced in the regions where vent apertures are located. For example, in some embodiments the canopy comprises vent apertures 51 located in a longitudinal extending reinforced edge region of the canopy to be positioned towards or near to a longitudinal edge of the canopy 10. For example, a longitudinal row or group 51 of vent apertures may be positioned in a longitudinally extending reinforced portion of the canopy located 5 cm to 50 cm, or 5 cm to 30 cm, or 5 cm to 20 cm, or about 10 cm from a longitudinal edge of the canopy. In some embodiments, the canopy comprises vent apertures 52 in a longitudinal extending reinforced region of the canopy positioned intermediate of the centre portion of the canopy and an edge region of the canopy. For example, a longitudinal row or group 52 of vent apertures may be positioned in a longitudinally extending reinforced portion of the canopy located between 10 cm from a longitudinal edge of the canopy and 15 cm from a centre 12 of the canopy, or 50 cm to 200 cm from a longitudinal edge of the canopy, or 50 cm to 150 cm, or 50 cm to 100 cm from a longitudinal edge of the canopy. The longitudinal reinforced portions of the canopy may comprise the construction as described for the centre reinforced portion of the canopy. For example the reinforced portions of the canopy, whether in a central region 19, an edge region 58, or a region 59 that is intermediate the edge and central regions may comprise heavier warp tapes and/or an additional layer or layers of sheet material and/or an additional plastic coating.

In one embodiment, the vent apertures 53 located near to a ridge of the canopy may be spaced apart along the longitudinal direction of the canopy at a distance of 20 cm to 200 cm, 20 cm to 150 cm, 20 cm to 100 cm, or 30 cm to 90 cm, or 40 cm to 80 cm, or 50 cm to 70 cm, or about 60 cm. In one embodiment, the vent apertures 52 located intermediate the ridge and longitudinal edge of the canopy may be spaced apart along the longitudinal direction of the canopy at a distance of 50 cm to 200 cm, 50 cm to 130 cm, or 60 cm to 120 cm, or 70 cm to 110 cm, or 80 cm to 100 cm, or about 90 cm. In one embodiment, the vent apertures 51 located near to or adjacent a longitudinal edge of the canopy may be spaced apart along the longitudinal direction of the canopy at a distance of 20 cm to 200 cm, 80 cm to 160 cm, or 90 cm to 150 cm, or 100 cm to 140 cm, or 110 cm to 130 cm, or about 120 cm. So in some embodiments, the vent apertures in the longitudinal centre portion or region may be spaced closer together along the length of the canopy compared to the vent apertures in the edge region and/or in the intermediate region. Alternatively, in some embodiments, the vent apertures in the edge region may be spaced closer together than the vent apertures in the centre portion. In some embodiments, the spacing between vent apertures in the edge may be the same as the spacing between the vent apertures in the centre region. In some embodiments the vent apertures in the intermediate region are spaced closer together than the vent apertures in the central region. In some embodiments, the spacing between vent apertures in the intermediate region may be the same as the spacing between the vent apertures in the centre region. In some embodiments, the vent apertures in the edge region are spaced closer together than the vent apertures in the intermediate region. In some embodiments, the spacing between vent apertures in the intermediate region may be the same as the spacing between the vent apertures in the edge region.

The vents can also be placed in other locations in the canopy. For example, vent apertures may be positioned as illustrated in FIGS. 1b, 1c and 1d, and/or vent apertures may be placed randomly throughout the canopy. Vent apertures located towards or near to a longitudinal edge of the canopy may be particularly useful for preventing water pooling on top of the canopy in a region extending along a longitudinal edge of the canopy. For example, in use, water running down the canopy may collect in a region near to the longitudinal edge of the canopy where the canopy is installed without sufficient tension to allow water to run off the canopy. The weight of the water can cause the canopy to form a concave shape near the longitudinal edge where water collects and builds up on the canopy. Vent apertures with covers near to the longitudinal edge may act as relief valves to allow water pooling or collecting in this region of the canopy to leak or drain from the canopy to avoid water remaining on or being captured by the canopy or the water is limited to an area beneath the location of the vent apertures in the edge region of the canopy (the amount of water cannot build up towards the centre of the canopy beyond the location of the vent apertures). This reduces the downward water pressure on the canopy caused by pooling water. In some embodiments the vent apertures in the edge region of the canopy are not covered by vent covers, as illustrated in FIG. 1d, to allow water at the edge region of the canopy to drain through the canopy via the vent apertures in the edge region. In some embodiments, the vent apertures in the edge region are spaced closer together than the vent apertures in the central region, to provide sufficient vent apertures in the edge region to allow water to leak through the canopy at the edge region to prevent the pooling of water at the edge region of the canopy. For example, in some embodiments, the vent apertures at the edge region are spaced apart by 20 cm to 200 cm, 20 cm to 150 cm, 20 cm to 100 cm, or 30 cm to 90 cm, or 40 cm to 80 cm, or 50 cm to 70 cm, or about 60 cm, whereas the vent apertures in the central region are spaced apart by 80 cm to 160 cm, or 90 cm to 150 cm, or 100 cm to 140 cm, or 110 cm to 130 cm, or about 120 cm.

The vent apertures may also allow air pressure due to wind or breeze to be released from beneath the canopy. Vent apertures may allow wind or breeze to pass through the canopy from below the canopy to ambient above the canopy. In a breezy or windy climate, wind passing below the canopy may cause the canopy to billow outwards, straining any securing features or support structures retaining the canopy in place. The vent apertures may allow wind or breeze to pass through the canopy and reduce billowing of the canopy in a windy climate. The vent apertures may allow cheaper or lighter weight securing devices to be used to secure the canopy.

In use, hot air accumulating under the canopy rises towards the ridge of the canopy. Vent apertures near to the top of the canopy near the ridge 12 allow hot air to exit the canopy to ambient air above the canopy. The vent covers restrict water above the canopy from entering the vent apertures to assist in maintaining a dry environment under the canopy in at least a central area under the canopy.

In some embodiments vent apertures in the longitudinally extending centre portion of the canopy have a larger diameter than the vent apertures in other regions of the canopy. For example the vent apertures 53 in the centre portion are larger than the vent apertures 51 in a longitudinal edge region of the canopy, and/or the vent apertures 52 in an intermediate region between the longitudinal edge region and the centre portion of the canopy. The larger diameter apertures provide for increased breeze or airflow to pass from beneath the canopy to exit the canopy to ambient air above the canopy. For example, the diameter of the vent apertures in the central portion of the canopy may comprise a diameter of 10 mm to 100 mm, 20 mm to 50 mm, or 25 mm to 45 mm, or 30 mm to 40 mm. The vent apertures in other regions of the canopy may comprise a diameter of 5 mm to 25 mm, or 10 mm to 20 mm, or 20 mm to 40 mm.

The larger sized vent covers required to cover the larger diameter vent apertures may be more prone to being blown open compared to vent covers over smaller diameter vent apertures. Preferably a vent cover lifts away from or is positioned from the vent aperture enough to allow sufficient air flow while preventing or significantly restricting water flow from outside the canopy.

As described above, in some embodiments, the vent cover may be formed from a folded piece or strip of material or a strip material formed into a cylinder and folded. An outer side of the strip or folded cylinder of material forms the vent cover, and an inner side of the strip or folded cylinder of material is attached to the canopy. For example the inner side is attached to the canopy by a grommet forming the vent aperture through the inner side and the sheet material of the canopy.

To restrict the amount the vent cover lifts away from the vent aperture, in some embodiments the vent cover is attached to the inner side of the strip or cylinder of material along a longitudinal edge 39 of the vent cover below the vent aperture, as illustrated in FIG. 8C. In some embodiments the outer side 37 is releasably attached to the inner side 38 along a longitudinal edge 39 of the vent cover below the vent aperture 30. For example, a hook and loop type fastener may be applied along the longitudinal edge of the vent cover and the inner side of the strip or cylinder of material below the vent aperture.

Further, in some embodiments, at least an upper portion of a lateral edge or edges 36 of the outer side are attached to the inner side. For example, the vent cover 34 is fixed to the inner side 38 from the top of the vent cover to approximately half way down each lateral edge 36 of the vent cover.

Where the inner side 38 of the strip or cylinder of material is not attached to the canopy main web or sheet material except around the perimeter of the vent aperture (for example by a grommet 32), and the vent cover 34 is attached to the inner side along longitudinal edges 35, 39 above and below the vent aperture 30, a breeze or air movement may cause the vent cover 34 and the inner side 38 of the vent cover material to billow outwards from the aperture, as illustrated in the cross sectional view of FIG. 8D. However, as the vent cover is attached to the inner side 38 along longitudinal edges 35, 39 above and below the vent aperture, the vent aperture always remains covered, even when a strong breeze blows through the vent aperture.

In some embodiments the lateral dimension of the vent cover between the longitudinal edges 35, 39 of the vent cover is greater than the lateral dimension of the inner side between the longitudinal edges 35, 39 so that the vent cover 34 arches or bows outwardly from the vent aperture, as illustrated in FIG. 8e. This embodiment helps to ensure the vent cover is spaced a distance from the vent aperture, even when there is no substantial breeze or air flow passing through the vent aperture to cause the vent cover to billow outwards. With the vent cover held or bowed outwards from the vent aperture, a low resistance path for venting air from below the canopy is provided, while the vent aperture remains covered.

In some embodiments, the vent cover may be formed from a sheet material comprising a particular weight suitable for an intended amount of air flow. The weight of the material of the vent covers may regulate the amount of air flow through the vent apertures. For example, a vent cover formed from a light weight sheet material may allow a higher flow of air through a vent aperture compared to a vent cover formed from a heavier weight sheet material. And a vent cover formed from a relatively intermediate weight material may allow a relatively intermediate flow rate of air through a vent aperture compared to lighter and heavier vent cover materials. This concept is illustrated in FIGS. 8f to 8h. In FIG. 8f, the vent cover 34a is formed from a light weight sheet material and lifts relatively easily away from the vent aperture to allow a larger air flow rate through the aperture. In FIG. 8g, the vent cover 34b is formed from a relatively intermediate weight sheet material and lifts less easily away from the vent aperture compared to vent cover 34a. In FIG. 8g, the vent cover 34c is formed from a relatively heavy weight sheet material and lifts less easily away from the vent aperture compared to vent covers 34a and 34b and allows a relatively smaller air flow rate through the vent aperture.

The vent cover that is also heavier will also take more wind force to be lifted than a lighter weight vent cover. Thus the weight of the vent cover may be chosen to regulate the amount of wind force required to lift a vent cover. Higher wind force will be required to lift the vent cover comprising a heavier weight material and thus a heavier weight vent cover will stay closer to the vent aperture in higher wind conditions and restrict rain associated with the wind from penetration though the vent aperture to the crop below. The vent cover is still not so heavy that it will not lift to allow a flow of air from beneath the canopy to reduce high wind pressure on the canopy.

In some embodiments the vent covers are formed from a relatively light weight sheet material comprising a weight of about 50 to 200 g/m2. In some embodiments the vent covers are formed from a relatively intermediate weight sheet material comprising a weight of about 200 to 400 g/m2. In some embodiments the vent covers are formed from a relatively heavy weight sheet material comprising a weight of about 400 to 1000 g/m2.

In some embodiments the vent covers are formed from a relatively light weight sheet material comprising a weight of about 50 to 100 g/m2. In some embodiments the vent covers are formed from a relatively intermediate weight sheet material comprising a weight of about 100 to 200 g/m2. In some embodiments the vent covers are formed from a relatively heavy weight sheet material comprising a weight of about 200 to 600 g/m2.

In some embodiments, the canopy may comprise some vent covers that comprise a relatively light weight sheet material, and some vent covers that comprise a relatively heavy weight sheet material. For example, the vent apertures in the longitudinally extending centre portion of the canopy may be covered with vent covers comprising a lighter weight material, and the vent apertures in other regions of the canopy may be covered with vent covers comprising a heavier weight material. The lighter weight material allows a higher air flow through the vent apertures in the centre of the canopy compared to flow through apertures covered with a heavier material in other regions of the canopy.

In some embodiments, the position of the vent aperture in the canopy determines the weight of the vent cover material. Vent covers over vent apertures positioned directly over a crop should have more resistance to lifting in windy conditions compared to covers over vent apertures that are not positioned directly over the crop. Therefore, for example, the vent covers over apertures in a central region of the canopy may comprise heavier weight material, and vent apertures in an edge region of the canopy may comprise lighter weight material, where the canopy is intended to be positioned centrally over a row of trees.

For example, the vent apertures in the central portion of the canopy may comprise vent covers comprising a material weight of 200 to 1000 g/m2, and the vent apertures in an edge region of the canopy may comprise vent covers over comprising a material weight of 50 to 200 g/m2.

In some embodiments vent apertures in one region of the canopy may have a larger diameter than the vent apertures in other regions of the canopy. For a larger diameter vent aperture, the vent cover is correspondingly larger compared to the vent covers over smaller vent apertures in the canopy. To assist with maintaining a cover over the larger apertures, in some embodiments the vent covers over the larger diameter apertures comprise a heavier weight material, and smaller diameter vent apertures in other regions of the canopy material are covered with vent covers comprising lighter weight material. Further, due to the larger surface area of the vent covers over larger vent apertures, the covers over larger vent apertures may be more prone to being lifted by wind passing over the canopy. To reduce the likelihood or occurrence of larger vent covers lifting away from larger vent apertures in windy conditions, in some embodiments the vent covers over larger vent apertures are formed from heavier weight material, and the vent covers over smaller vent apertures are formed from lighter weight material. For a canopy, the material weight of vent covers over larger vent apertures in the canopy may be heavier than the material of vent covers over smaller vent apertures in the canopy so that the vent covers over the larger apertures and the vent covers over the smaller apertures require a similar amount of wind force to lift away from the larger and small vent apertures. This provides even or uniform protection for plants below the canopy regardless of where the plants are positioned beneath the canopy.

For example, the diameter of the vent apertures in a first region (for example a central portion) of the canopy may comprise a diameter of 10 mm to 100 mm, 20 mm to 50 mm, or 25 mm to 45 mm, or 30 mm to 40 mm or 40 mm to 50 mm, and the vent covers over the vent apertures in the first region of the canopy may comprise a material weight of 200 to 1000 g/m2. In comparison, the vent apertures in second region (for example an edge region) of the canopy may comprise a diameter of 5 mm to 25 mm, or 10 mm to 20 mm, and the vent covers over the vent apertures in the second region of the canopy may comprise a material weight of 50 to 200 g/m2.

Conversely, larger diameter vent covers may comprise lighter weight material vent covers compared to other smaller diameter vent covers, so that an even greater increased flow of air is achieved through the larger vent apertures.

In some embodiments the canopy comprises vent covers formed from a heavier weight sheet material than the sheet material of the main portion of the canopy. In some embodiments the canopy comprises vent covers formed from a lighter weight sheet material than the sheet material of the main portion of the canopy. In some embodiments, some vent aperture covers are formed from a heavier weight sheet material, and some vent covers formed from a lighter weight sheet material, and the main portion of the canopy is formed from an intermediate weight sheet material.

In some embodiments the vent covers are formed from the same weight sheet material as the sheet material of the main portion of the canopy.

In very windy environments the vent apertures may not provide sufficient venting surface area to allow sufficient air flow from below the canopy.

In some embodiments, the canopy may comprise a venting region at or adjacent to the central region of the canopy. In windy environments, wind flow below the canopy may rise up the canopy to exit the canopy via the vent region to prevent the canopy billowing outwards. The venting region thus reduces force on the canopy, fasteners fastening the canopy to supporting structures, and supporting structures holding the canopy in place.

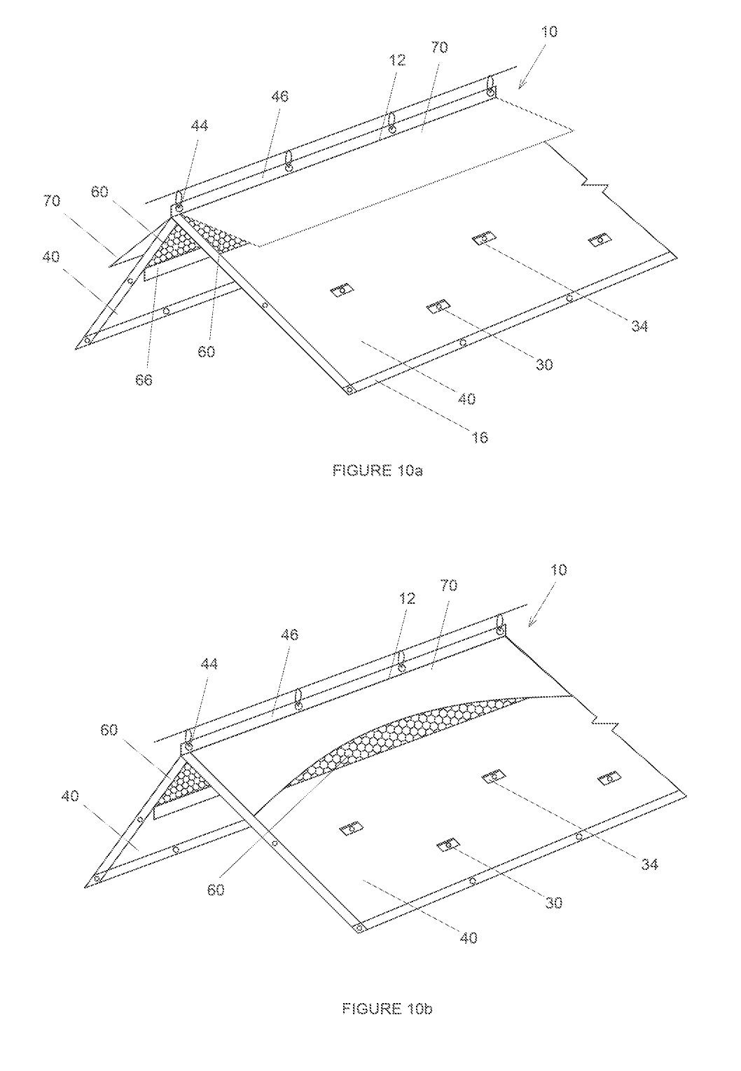

FIGS. 10a and 10b illustrate embodiments of a canopy comprising a venting region 60. In some embodiments a vent region cover 70 may cover the venting region 60. The cover 70 restricts water from flowing or entering the vent region and passing from outside the canopy to inside the canopy and onto the plants but allows air to move upwards though the vent region.

In some embodiments the venting region may comprise netting material. In some embodiments, the venting region extends longitudinally along the length of the canopy, for example in a region of the canopy bridging the apex or ridge line of the canopy in use. In some embodiments, the venting region may be formed in sections spaced apart along the length of the canopy. In some embodiments, the cover 70 extends longitudinally along the length of the canopy to cover the venting region. In the embodiment of FIG. 10a, the lateral ends of the cover 70 are not affixed to the lateral ends of the canopy. In the embodiment of FIG. 10b, the lateral ends of the cover 70 are affixed to the lateral ends of the canopy to prevent weather (rain) passing from outside or above the canopy to inside or below the canopy at the lateral ends of the canopy. In FIG. 10b, the cover is illustrated as being lifted away from the venting region 60 so that the venting region below the cover 70 may be viewed in the Figure.

In some embodiments the venting region extends along one or both sides of the ridge 12 of the canopy. The venting region may extend up to 100 mm, or 200 mm or 300 mm or 400 mm or 500 mm or 600 mm or 700 mm or 800 mm or 900 mm or 1000 mm or 1500 mm from the ridge of the canopy in the width direction of the canopy, on one or both sides of the ridge. The cover preferably overlaps the venting region completely. For example, where the venting region extends 400 mm from the ridge of the canopy, the cover may extend 500 mm from the ridge.

In an alternative embodiment the venting region is spaced from the ridge 12 or central region of the canopy to be located intermediate between the ridge and a longitudinal edge 16 of the canopy.

The venting region cover 70 may be formed from a strip of material. The venting region cover material may be woven from flat warp and weft tapes of a plastics material or woven from flat warp and weft tapes of a plastics material that has later been coated on one or both sides. Alternatively the cover material could be plastics film. In some embodiments the venting region cover is formed from the same sheet material as the canopy sides.

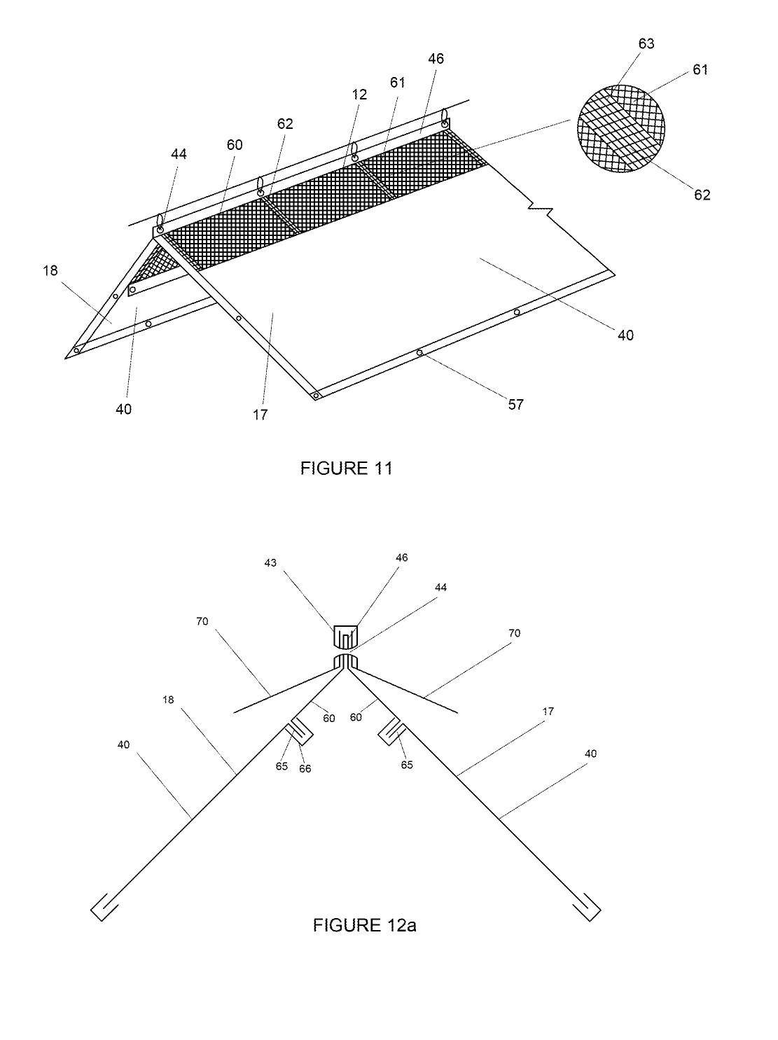

FIG. 11 illustrates the canopy with the venting region cover omitted. In the illustrated embodiment, the venting region comprises a netting material extending longitudinally along the canopy. In some embodiments the netting may be expandable netting. Expandable netting is netting that may be pulled taunt in one or more directions to elongate the apertures of the netting in the direction the netting is pulled. The expandability of the netting in the vent region is a property of the netting that may be undesirable. Expansion of the netting may cause the overall dimensions of the canopy to be variable, resulting in the canopy being difficult to fasten securely. Expansion of the netting in a longitudinal direction may not result in the canopy being expandable in the longitudinal direction, as the canopy sheet material 40 extending the length of the canopy may have no or minimal stretch. Where the netting material extends along the full length of the canopy, stretch in the netting results in the canopy being expandable or stretchable in the width direction which may be undesirable as explained above.

To prevent or reduce the amount of stretch of the canopy caused by stretch in the netting of the venting region, in some embodiments the canopy is provided with strips or belts of material extending in the width direction of the canopy across the venting region. With reference to FIG. 11, the belts 62 are spaced apart along the longitudinal direction of the canopy and extend across the venting region to join or connect to the canopy material 17, 18 either side of the venting region, or between the ridge line 12 and the sides 17, 18 of the canopy. The stretch of the belts 62 is less than the stretch of the netting 60, thus reducing the stretch of the canopy in the width direction. The belts make the canopy dimensionally stable. In some embodiments the belts may be straps or strips formed of material woven from flat warp and weft tapes of a plastics material or woven from flat warp and weft tapes of a plastics material that has later been coated on one or both sides. Alternatively the belt material could be plastics film. In some embodiments the venting region belts are formed from the same sheet material as the canopy sides.

In a preferred embodiment the belts 62 extending across the netting of the venting region are integrally formed with the netting. For example, the belts are a knitted section of the netting of the venting region of the canopy. For example, the netting material 60 comprises venting portions 61 and belt sections 62. The venting portions 61 of the netting 60 comprise a first knitted construction and the belt sections 62 of the netting 60 comprise a second knitted construction, the second construction having a lower amount of stretch compared to the first construction. The first part of the knitted structure is 61 has less coverage than 62, so it allows more air movement than the area of 62 but 62 acts to restrict the expandability of 61. The netting material comprises spaced part belt sections knitted into the netting material at the time the netting material is knitted/manufactured.

In some embodiments, the netting in the belt sections 62 of the netting 60 may comprise a construction comprising a higher density compared to the density of the venting sections 61 of the netting 60. For example, the belt sections of the netting may comprise apertures of 1 mm to 3 mm in size, which could be made from a pillar type construction, whereas the venting portions of the netting may comprise apertures of 5 mm to 20 mm in size which could be made from a diamond, hexagonal, or triangular aperture or other pattern type construction. The higher density or pillar type construction results in a reduced amount of stretch in the belt sections of the netting and added strength at the belt sections of 62. The netting material 60 with integrally formed or knitted belt sections provides the openness of the areas of 61 allowing air flow combined with the strength and lack of expandability of the belt sections 62.

In some embodiments, the netting in the belt sections 62 of the netting 60 may comprise a knitted construction comprising a higher knitted density compared to the knitted density of the venting sections 61 of the netting 60.

In some embodiments the belt sections 62 of the netting comprise a different aperture shape to the venting sections 61 of the netting. For example, the venting sections 61 of the netting may comprise a diamond shape knit that may stretch when pulled taunt in the longitudinal and lateral directions of the canopy, and the belt sections 62 of the netting may comprise a pillar construction, the pillars 63 of the netting aligned in the lateral or width direction of the canopy. A pillar type knit has low or lower stretch along the length of the pillars 63 of the netting. Aligning the pillars in the width direction of the canopy reduces the amount of stretch of the canopy in the width direction. While the diamond part, 61 is more flexible in both directions. The incorporation of the two types of net construction enables the benefits of the two to be available for where they are best utilised.

In some embodiments, securing features 44 near the ridge line and/or securing features 57 at longitudinal edges may be aligned with the belts or belt sections 62 of the venting region. The canopy may be pulled taunt in the width direction, with little stretch in the width direction provided by securing features at the canopy apex and at the canopy longitudinal edges being in line with the belts of the venting region, as illustrated in FIG. 11. If the areas of 62 were not present the width of the fabric would not be able to be controlled that same way as with the areas 62.

The belts 62 across the venting region of the canopy may be spaced apart along the length of the canopy by a spacing of between 100 mm and 10 m. In some embodiments the belts are spaced apart by, 200 mm to 2 m and further 300 mm to 1 m.

In some embodiments the belt sections of the venting region are between 20 mm and 100 mm in width.

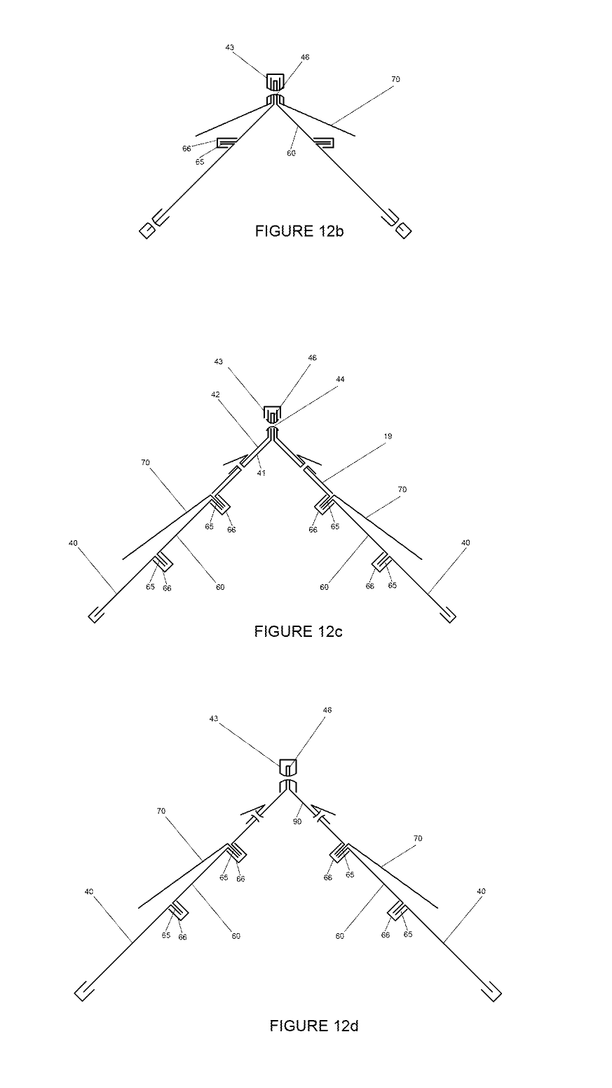

With particular reference to FIG. 12a, the canopy may be constructed from plastics sheet material 40 to form a majority of each of the canopy sides 17, 18. A longitudinal edge of the sheet material is attached to a longitudinal edge of the netting of the venting region. To provide sufficient strength in the join between the netting 60 and the sheet material 40 the longitudinal edges of the netting and sheet material may be lapped or joined together to form a flap 65. The edges of the netting and sheet material secured together by heat sealing, adhesive bonding or sewing. The secured edge portions form the flap 65. One or more extra material layers may be included in the flap. For example a covering layer 66 of plastics material may be folded over the outside of the flap and be heat bonded, adhesively bonded or sewn to the flap. The join flap 65 may be formed to the inside or lower side of the canopy as in 12a or to the outside or top side of the canopy as shown in FIG. 12b.

At the ridge or centre of the canopy the netting material may be formed into a flap 46 similar in construction to earlier embodiments. The flap 46 may be formed by a double layer of the netting material, the layers secured together by heat sealing, adhesive bonding or sewing. One or more extra material layers may be included in the flap. For example a covering layer 43 of plastics material may be folded over the outside of the flap and be heat bonded, adhesively bonded or sewn to the flap. The layer 43 may be sufficiently wide to substantially cover both faces of the flap. As illustrated in embodiments of FIGS. 12a and 12b, the venting region cover 70 may be integrated into the flap 46 forming an additional covering layer for the flap 46. Alternatively, the venting region cover 70 on each side of the flap 46 may be fixed or attached to a side of the flap 46, with an additional layer 43 covering flap 46 and an edge region of each cover 70 incorporated into the flap. Securing features 44 may be provided to the flap as described with reference to earlier embodiments. As described with reference to the embodiment of FIG. 4, flap 46 may be formed to the inside of the canopy.

In some embodiments, the canopy may comprise a venting region 60 and a central reinforced region as described earlier, for example with reference to FIG. 1a. An example construction is illustrated in FIG. 12c. The venting region may be provided at both sides, or just one side, 17, 18 of the canopy intermediate between the sheet material 40 of the sides and the reinforced central portion 19. Flaps 65 may be formed at the joins between the sheet material of the sides 17, 18 of the canopy and the venting region nettings, and between the venting region netting and the centre reinforced portion. The reinforced centre portion 19 comprises at least two material layers. In the illustrated embodiment, the reinforced central portion comprises a sheet material, for example the sheet material forming the main parts of the sides of the canopy, and an additional layer 42 of sheet material. In the illustrated embodiment, the additional layer may extend from the reinforced portion 19 to form the venting region covers 70. The layers 41, 42 may be fixed together by any suitable means, such as bonding with adhesives or by heat, or by stitching, or an additional plastic coating or a combination of these methods, or is made of two layers of woven fabric pressed together with a coating on the outside of the two layers, one on the upside and down side, two layers of coating, to seal and hold the two layers of woven fabric together. Preferably the layers of the centre portion are heat bonded along lines or across areas or across substantially its entire area.

In the illustrated embodiments the canopy includes securing features within the region of the reinforced centre portion 19 and preferably in the flap 46 as described earlier with reference to earlier embodiments.

In some embodiments, the canopy may comprise a venting region 60 intermediate between a central region of the canopy and a longitudinally extending edge of the canopy. For example, FIG. 12d illustrates venting region 60 intermediate between central region 90 and longitudinal edge 16. In some embodiments, an edge of the venting region cover 70 may be secured to the central region to extend over the venting region 60. In the illustrated embodiment, an edge of the cover 70 is incorporated into flap 66.

As illustrated in the accompanying FIGURES, the venting region cover is secured to the canopy along a longitudinal edge above the venting region. In some embodiments, the venting region cover may be secured to the canopy at or near to the ridge 12 of the canopy. The cover may move between a closed position covering the venting region to an open position where the cover moves away from the venting region to allow air flow through the venting region. In some embodiments the canopy may be provided with a member or members that limit the amount the venting region cover may open or move away from the venting region of the canopy.

In some embodiments, the venting region cover 70 is provided with an elastic element or elements to bias the cover 70 towards a closed position over the venting region. It may be desirable to bias the cover 70 to a closed position so that the cover does not remain in an open position, for example once a breeze drops.

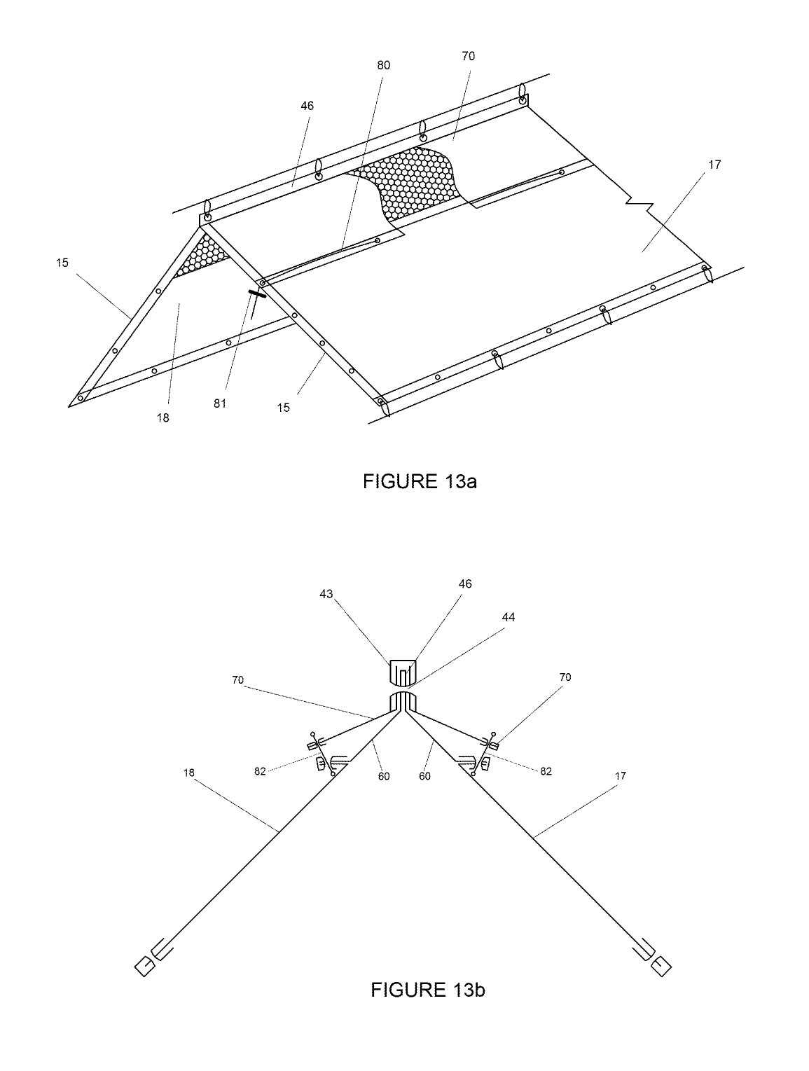

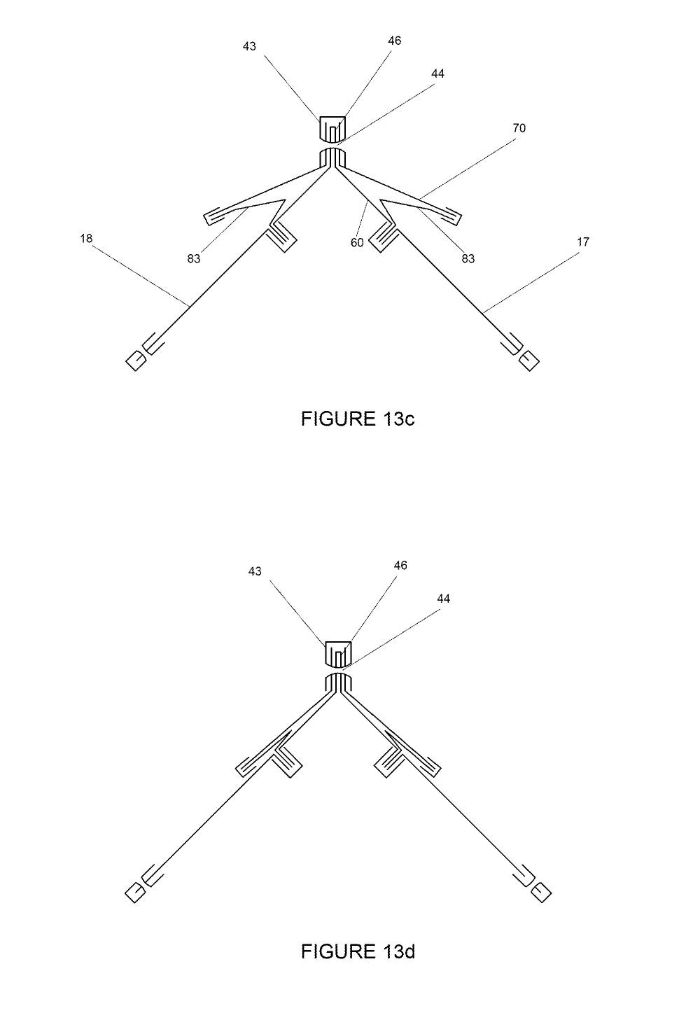

In the embodiment of FIG. 13a, the canopy comprises an elastic member 80 that extends along the length of the canopy. The elastic member is threaded through eyelets or grommets in the venting region cover and the canopy material below the cover. Where the cover is moved away from the venting region (for example under the force of a breeze passing through the venting region), the elastic member is stretched. Tension in the stretched elastic member biases the cover back towards the closed position. Alternatively the elastic member may be threaded though loops of material fixed to the cover and/or the sides of the canopy. In some embodiments, the elastic member 80 extends through eyelets or grommets in the flap 66 at the join between the venting region material 60 to the canopy sheet material 40.

In the embodiment of FIG. 13a, the elastic member 80 extends along the length of the canopy. A user may adjust the length of the elastic member to adjust the amount of tension or biasing force the member provides to close the cover. One or both ends of the elastic member 80 may be provided with a buckle or clip 81 for adjusting the length of the elastic member secured between the ends 15 of the canopy. The elastic member 80 may comprise one or more elastic bands or threads, for example a bundle of rubber members such as a bungee cord or rubber cord.

With reference to FIG. 13b, in some embodiments, the canopy may comprise elastic members 82 spaced apart along the length of the canopy, each member 82 extending between a side 17, 18 of the canopy and the venting region cover. For example, members 82 may comprise an elastic band stitched to the cover and canopy side, or tied through eyelets in the canopy side and cover. In some embodiments, the elastic band may extend between the cover 70 and the flap 65, 66 joining the venting region material 60 to the canopy sheet material 40. For example, the elastic band may be stitched or otherwise fixed to the cover 70 and flap 66, or may extend through eyelets in the cover and the flap 66.

With reference to FIGS. 13c and 13d, in some embodiments the canopy may comprise webbing members 83 spaced apart along the length of the canopy, each member 83 extending between a side 17, 18 of the canopy and the venting region cover. For example, members 83 may comprise a folded strip of material. With the cover in the closed position against the venting region, the webbing member is folded flat, two sides of the webbing member folded together as shown in FIG. 13d. With the cover moved away from the venting region, the folded webbing member opens, the sides of the folded member separated to allow the cover 70 to move away from the venting region as illustrated in FIG. 13c. The webbing member may be bonded or stitched or otherwise fixed to the sides of the canopy and venting cover. The webbing members may be woven from flat warp and weft tapes of a plastics material or woven from flat warp and weft tapes of a plastics material that has later been coated on one or both sides. Alternatively the webbing members could be plastics film or a knitted belt like material. In some embodiments the webbing members are formed from the same sheet material as the canopy sides. In some embodiments the webbing members may be elastic strips.

As shown in FIGS. 10a, 10b and 12c, in some embodiments the canopy may comprise vent apertures 30 as described earlier, for example with reference to the embodiment of FIGS. 1b and 1c.

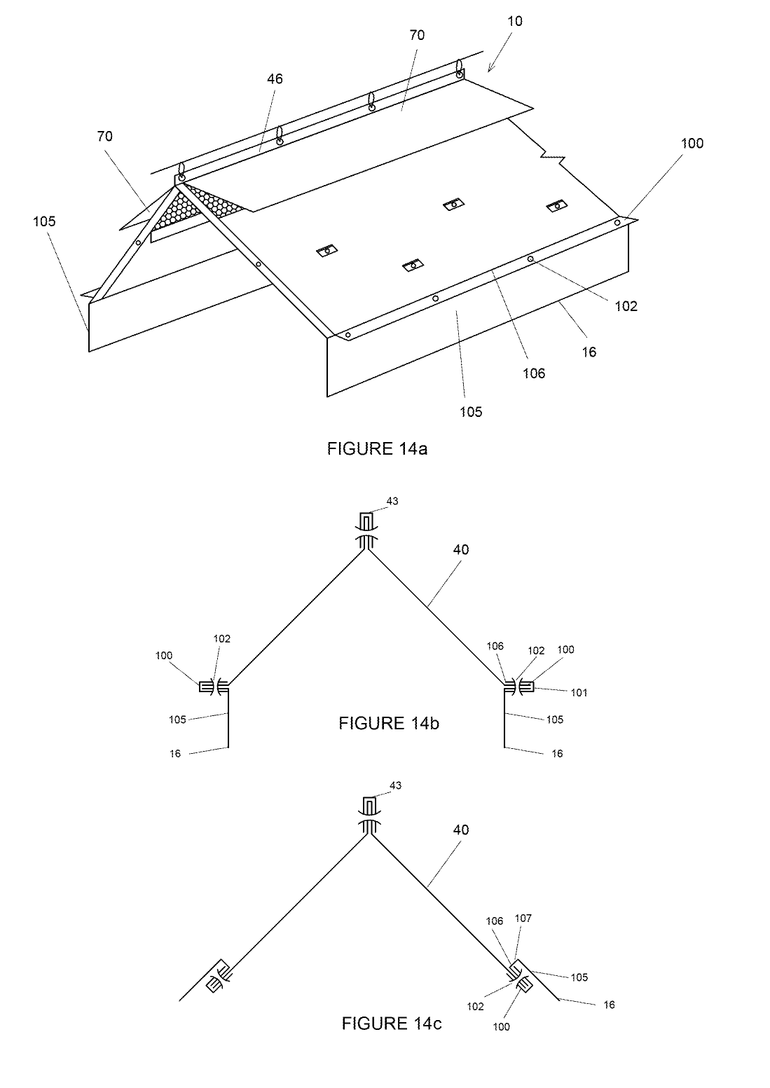

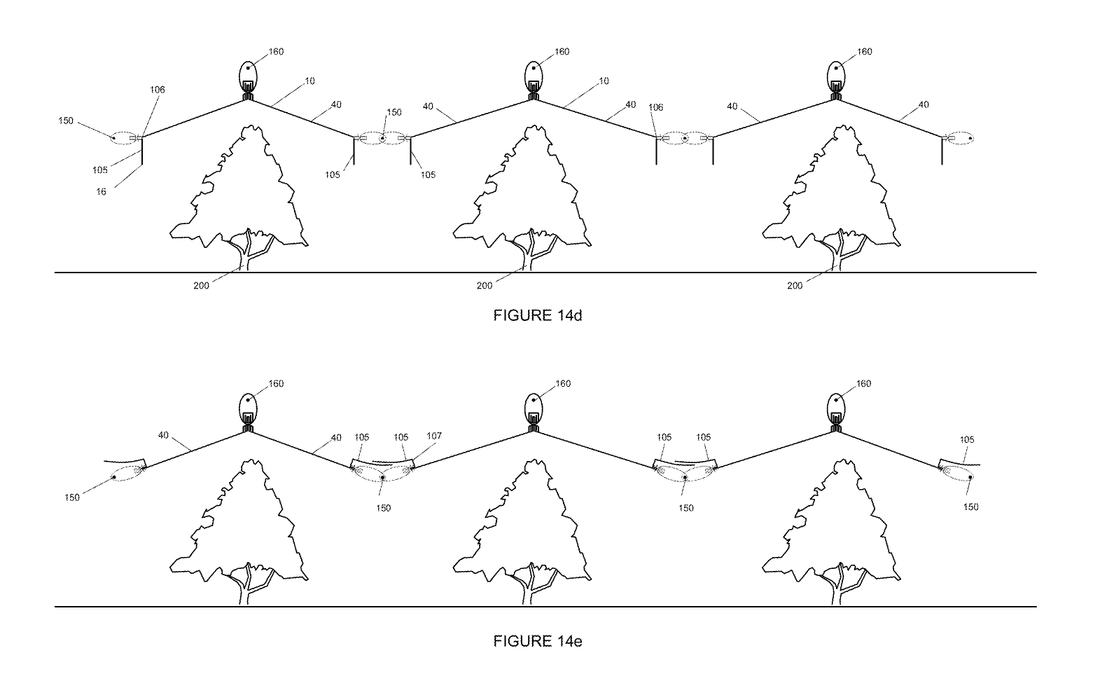

In some embodiments the canopy comprises a longitudinal fixing portion or flap positioned a distance from a longitudinal edge of the canopy. The fixing portion or flap 100 is illustrated in FIGS. 14a and 14b. The fixing portion or flap may comprise two layers of the sheet material of canopy. In some embodiments, the fixing flap 100 is folded from a fold region of the sheet material of the canopy along a longitudinal fold line at a distance from a longitudinal edge 16 of the canopy so that a portion 105 of the width of the canopy located outside the fixing flap is integrally formed with the main portion of the canopy. Alternatively, instead of being folded from the canopy sheet material, the portion 105 may comprise a separate section of sheet material fixed to the sheet material of the main portion of the canopy at or adjacent to the longitudinal edge of the main portion of the canopy. In some embodiments, the portion 105 is fixed to the sheet material of the main portion of the canopy at the longitudinal edge of the main portion of the canopy so that the fixing flap comprises two layers of sheet material, one layer from the main portion of the canopy and a second layer from the sheet material of the portion 105, as illustrated in FIG. 14b. In some embodiments, the portion 105 is fixed to the sheet material of the main portion of the canopy adjacent the longitudinal edge of the main portion of the canopy so that the fixing flap comprises one layer of sheet material from the main portion 40 of the canopy.

Securing features, for example eyelets 102 are formed in the fixing flap for securing the canopy 10 to a support structure.

In some embodiments the fixing flap 100 comprises a strip of material 101 attached to the sheet material of the fixing flap to reinforce the flap. The eyelets are provided through the strip of material and the sheet material of the fixing flap. In some embodiments the strip of material is provided to one side of the fixing flap. In some embodiments the strip of material is folded to be provided to both sides of the fixing flap.

In some embodiments the fixing flap comprising eyelets or similar may have a height of 35 mm to 150 mm. In some embodiments the fixing flap has a height of 100 mm.

The portion 105 forms a longitudinal border or cover portion 105 extending from a longitudinal edge 106 of a main portion 40 of the canopy. It is to be understood that description of the location of vent apertures in the canopy given as a distance from a longitudinal edge of the canopy provided earlier is to be understood to be in relation to the longitudinal edge 106 of the main portion of the canopy in embodiments comprising a cover portion 105.

In some embodiments the fixing flap is formed 50 mm to 3 m from a longitudinal edge 16 of the canopy so that the width of the cover portion is 50 mm to 3m wide. In some embodiments the fixing flap is formed 50 mm to 2 m from a longitudinal edge of the canopy, or 50 mm to 1 m from a longitudinal edge of the canopy, or 100 mm to 700 mm from a longitudinal edge of the canopy, or 200 mm to 600 mm from a longitudinal edge of the canopy, or 300 mm to 500 mm from a longitudinal edge of the canopy so that the cover portion 105 is 50 mm to 3 m wide, or 50 mm to 2 m wide, or 50 mm to 1 m wide, or 100 mm to 700 mm wide, or 200 mm to 600 mm wide, or 300 mm to 500 mm wide.

Preferably the canopy comprises two fixing flaps 100, each flap located a distance from a corresponding longitudinal edge of the canopy as illustrated in the FIGURES.

As illustrated in FIGS. 14a and 14b the fixing flap 100 may extend from the main portion 40 of the canopy and the cover portion 105 of the canopy so that the cover portion extends from below the main portion of the canopy. In an alternative embodiment the fixing flap 100 may extend from the main portion and the cover portion so that the cover portion extends from above the main portion of the canopy, as shown in FIG. 14c.

The longitudinal fixing flap 100 comprising eyelets is especially useful for anchoring the canopy to posts or structures above a row of trees. The cover portion 105 of the canopy can hang below the fixing flap 100 to cover at least a portion of the sides of trees or plants below the main portion of the canopy. The cover portion 105 forms a vertical wall or curtain to protect the sides of the trees or plants from rain approaching the canopy from a side of the canopy. The fixing flap is provided at the longitudinal edge 106 of the main portion of the canopy for securing the edge of the canopy to a support structure, so that in use the cover portion 105 hangs below the main portion of the canopy from inside the securing features. The fixing portion or flap forms a longitudinal edge of the main portion 40 of the canopy. This arrangement allows the canopy to be held above the trees or plants at a distance from the trees, so that an air gap is present between the canopy and the trees or plants. Furthermore, the cover portion 105 can be arranged to contact the ground so that there are no gaps between the edge of the canopy and the ground, or where adjacent canopies are erected above the ground side-by-side, the portion 105 may extend to cover a gap between adjacent canopies. Where the eyelets are attached to a wire, then a scalloping gap that may form between the points of attachment at each eyelet may be filled or covered with the side portion 105 of the width of the canopy provided outside the fixing flap 100. This assists to prevent birds or insects passing around the canopy and/or shields plants below the canopy from weather. Where eyelets are provided at the edge 16 of the canopy, gaps between the edge 16 of the canopy and the ground or an adjacent canopy may be difficult to close due to scalloping or dishing of the canopy between connection points or eyelets 102.

FIG. 14d shows adjacent rows of trees 200 protected by canopies 10 according to the embodiment of FIG. 14b. Each row of trees is protected by a canopy 10. As shown, each canopy comprises a longitudinal cover portion 105 that hangs from a longitudinal edge 106 of a main portion 40 of the canopy. The cover portions 105 extend from below the main portion of the canopy and from inside the eyelets 102. The longitudinal edges of the canopies are secured, for example, to longitudinally extending wires 150 via the eyelets 102 that are positioned outside the cover portions 105. There may be two wires 150 between adjacent canopies 10, one wire for each side of each canopy attached to the eyelets of the fixing flap via a suitable attachment device such as a wire or steel or plastic clip, the one wire each side allow the canopies to more independent of the adjacent canopy. The ridge of each canopy is secured to a longitudinally extending wire 160. Longitudinally extending wires 160 are secured between supporting poles or other support structure (not illustrated in FIG. 14d).

The cover portions form curtains and allow the main portion 40 of the canopy to be narrower than it otherwise would be if the curtains were absent, while providing a given amount of protection from rain approaching the canopy from a side of the canopy. The curtains 105 provide an increased amount of vertical protection (against horizontally directed rain) without increasing the width of the canopy. Having a narrower canopy can be beneficial as more sunlight may reach the ground between adjacent rows of trees. Reflective ground matting material may be used in between adjacent rows of trees to reflect sunlight back up and underneath the canopies to provide improved growing conditions, while maintaining protection from rain entering from the side where such protection is desirable. The covering portions 105 can allow for an increased gap between adjacent canopies while maintaining protection from rain hitting the canopy from above at an angle. At times of high wind and rain together, the canopy will tend to lift at the edges of the canopy to expose a greater portion of the plant beneath the canopy. The width of the canopy could be extended further to meet an adjacent canopy. However, preferably a gap is maintained between adjacent canopies to provide room for installation of the canopies. The gap between adjacent canopies allows for some rain to enter and hit the plants beneath, however, the cover portions 105 extending vertically reduces the risk of side rain entering the crop. The cover portions 105 also have the added advantage of increasing the possibility of trapping air under the canopies to retain warm air beneath. Warm air rises from under the canopy to collect at the apex or ridge of the canopy. The warm air may build up under the canopies to an extent where the warm air extends downwards from the ridge line until the warm air reaches the longitudinal edges 16 of the canopy at the bottom of the covering portions or curtains 105 where it can flow outwards from beneath the canopy. The cover portions 105 increases the collection volume for warm air and delays the out flowing of the warm air at the edges of the canopy.

As described above, in some embodiments the fixing flap 100 comprising securing features 102 may extend from the sheet material so that the covering portion extends from above the main portion of the canopy, as shown in FIG. 14c. In use the longitudinal cover portion 105 extends from above the main portion of the canopy to beyond the longitudinal edge 106 of the main portion of the canopy.

In the illustrated embodiment of FIG. 14c, a join between the main portion of the canopy 40 and the cover portion 105 forms the fixing flap 100, so that the fixing flap comprises two layers of sheet material, one layer from the main portion of the canopy and a second layer from the sheet material of the portion 105. In this embodiment, so that the covering portion extends outside the longitudinal edge 106 of the main portion of the canopy in use, the cover portion 105 is folded along a longitudinal fold line 107 to lie over the join and the securing features to extend outside the longitudinal edge of the main portion of the canopy.

FIG. 14e shows adjacent rows of trees 200 protected by canopies 10 according to the embodiment of FIG. 14c. Each row of trees is protected by a canopy 10. As shown, each canopy comprises a longitudinal cover portion 105 that extends from above the main portion of the canopy. The cover portions 105 extend from above the main portion of the canopy and from inside the eyelets 102. As shown, the longitudinal edges 106 of the canopies are secured, for example to a longitudinally extending wire 150, or they may also just rest on wire 150. There may be two wires 150 between adjacent canopies 10, one wire for each side of each canopy attached to the eyelets of the fixing flap via a suitable attachment device such as a wire or steel or plastic clip. The ridge of each canopy is secured to a longitudinally extending wire 160. The cover portions 105 extend from above the main portion of the canopy and from inside the securing features to extend outwards from the longitudinal edges 106 of the canopy so that the cover portions of adjacent canopies overlap above the support structure, for example wire or wires 150.

In some embodiments, the cover portions of adjacent canopies may be attached or secured together. For example, the cover portion of a first canopy may comprise an attachment feature and the cover portion of a second adjacent canopy may comprise a corresponding attachment feature for securing to the attachment feature of the first canopy. In some embodiments the cover portion may comprise an attachment feature for attaching the cover feature to a support structure.

In some embodiments, the cover portions comprise eyelets or grommets spaced apart along the length of the cover portions. In use, once adjacent canopies are installed side-by-side as shown in FIG. 14e, an elastic member may be threaded along the overlapping cover portions through the eyelets of both overlapping cover portions to secure the overlapping cover portions together. Where the overlapping cover portions are moved apart (for example under the force of a breeze passing past the cover portions), the elastic member may stretch. Tension in the stretched elastic member biases the cover portions back towards each other. In some embodiments an elastic member may be threaded through the eyelets in the cover portion and around looped around a support structure, for example wire 150, to secure the cover portion to the wire. Alternatively, a non-elastic member may be threaded through the eyelets in the overlapping cover portions and/or to wire 150 along the length of the canopy, for example a steel wire. In some embodiments clips may be used to attach the cover portion to wire 150. Alternatively the cover portions may comprise loops of material for receiving an elastic member. For example, the cover portion of one canopy may comprise loops of material applied to the bottom surface and an adjacent cover may comprise loops of material applied to the top surface of the cover portion so that the elastic material can pass along the overlapping cover portions and through the loops. The elastic member may extend along the length of the canopies. A user may adjust the length of the elastic member to adjust the amount of tension or biasing force the member provides to hold the cover portions together. One or both ends of the elastic member may be provided with a buckle or clip for adjusting the length of the elastic member secured between the ends of the canopy. The elastic member may comprise one or more elastic bands or threads, for example a bundle of rubber members such as a bungee cord or rubber cord. Alternatively the attachment features may be buckles and corresponding straps, or male/female pairs of couplers such as spring snap buttons, or a clamping device for clamping the overlapping cover portions together and/or to wire 150.

In one in-field arrangement, clips or wires or cord may extend between the fixing flaps of adjacent canopies. For example the eyelets 102 of the fixing flaps 100 of two adjacent canopies may be secured together. The clips or wires or cord spanning between the fixing flaps of adjacent canopies are spaced apart along the canopies or extend along the canopies below the cover portions 105 and support the cover portions 105 extending between the main portions of the adjacent canopies.

The overlapping cover portions 105 of adjacent canopies acts to prevent or reduce rain passing below the canopies. Furthermore, where there is a breeze or air flow, the overlapping cover portions 105 may lift to allow the air flow to pass. The cover portions 105 when overlapped as illustrated in FIG. 14e may give some sealing to the warmed air beneath the canopy. As the cover portions 105 extend from the upper surface of the main portion of the canopy, the cover portions may overlap with adjacent canopies without being fixed at the longitudinal edges 16 of the canopy. The cover portions, being over lapped and not fixed at their edges allow a release point during strong winds under the canopy. When there is strong wind the overlapping cover portions may lift to release the air and then fall back to the resting position as the strong wind is reduced.

In some embodiments the canopy comprises a lateral fixing flap a distance from a lateral edge of the canopy. The lateral fixing flap may comprise at least two layers of sheet material. Fixing features such as eyelets are spaced apart along the fixing flap. In some embodiments, the lateral fixing flap is folded from a fold region of the sheet material of the main portion of the canopy along a lateral fold line at a distance from a lateral edge of the canopy.

The lateral flap comprising eyelets is especially useful for anchoring the canopy to posts or structures above a row of trees. A portion of the length of the canopy located outside of the lateral flap forms a cover portion that can extend beyond the lateral flap to cover sides of trees or plants below the elevation of the main portion of the canopy. This arrangement allows the canopy to be held above the trees or plants at a distance from the trees, so that an air gap is present between the canopy and the trees or plants. Furthermore, where adjacent canopies are erected above the ground end-to-end, the cover portion outside lateral fixing flap can be arranged to cover a gap between adjacent canopies. The lateral fixing flap may be formed by joining an edge portion of the main part of the canopy and an edge of the portion of the canopy extending outside of the lateral fixing flap.

In some embodiments the lateral flap comprises a strip of material attached to the sheet material to reinforce the flap. The eyelets are provided through the strip of material and the sheet material. In some embodiments the strip of material is provided to one side of the flap. In some embodiments the strip of material is provided to both sides of the flap with the sheet material sandwiched between.

In some embodiments the lateral flap may have a height of 35 mm to 150 mm. In some embodiments the lateral fixing flap has a height of 100 mm. In some embodiments the lateral flap is formed 80 mm to 500 mm from a lateral edge of the canopy. In some embodiments the portion of the canopy located outside of the lateral fixing flap 100 is 50 mm to 3 m wide, or 50 mm to 2 m wide, or 50 mm to 1 m wide, or 100 mm to 700 mm wide, or 200 mm to 600 mm wide, or 300 mm to 500 mm wide.

In some embodiments the canopy comprises a lateral flap at each end of the canopy. The lateral flap may extend from the sheet material to be located above the canopy in use. In an alternative embodiment the lateral fixing flap may extend from the sheet material to be located below the canopy in use.

The foregoing describes the invention including preferred forms thereof. Alterations and modifications as will be obvious to those skilled in the art are intended to be incorporated in the scope hereof as defined in the accompanying claims.

1. A canopy comprising sheet material forming a main portion of the canopy having a greater length than width, vent apertures in the sheet material and vent covers over the vent apertures, wherein each vent cover is formed from a piece or strip of material folded about a longitudinal fold line, the vent aperture being formed through an inner side of the piece or strip of material and the sheet material of the canopy, and an outer side of the piece or strip of material forming the vent cover over the vent aperture.

2. A canopy according to claim 1 wherein the canopy comprises vent apertures in a longitudinally extending centre portion of the canopy.

3. A canopy according to claim 1 wherein the canopy comprises vent apertures in a longitudinal edge region of the canopy.

4. A canopy according to claim 1 wherein the canopy comprises vent apertures in a longitudinally extending centre portion of the canopy and vent apertures in a longitudinal edge region of the canopy and the vent apertures in the centre region are spaced closer together along the length of the canopy, or spaced further apart along the length of the canopy, compared to the vent apertures in the edge region of the canopy, and/or the vent apertures in the centre region comprise a larger diameter than the vent apertures in the edge region of the canopy.

5. A canopy according to claim 1 wherein the canopy comprises vent apertures in a longitudinally extending centre portion of the canopy and vent apertures in a longitudinal edge portion of the canopy and the vent apertures in the edge portion are spaced closer together along the length of the canopy compared to the vent apertures in the centre portion of the canopy.

6. A canopy according to claim 1 wherein the canopy comprises vent apertures in a longitudinally extending centre portion of the canopy and vent apertures in a longitudinal edge region of the canopy and the vent apertures in the centre region comprise a larger diameter than the vent apertures in the edge region of the canopy.

7. A canopy according to claim 1 wherein the canopy comprises vent apertures in a longitudinal intermediate region of the canopy between a longitudinally extending edge region of the canopy and a longitudinally extending centre portion of the canopy.

8. A canopy according to claim 1 wherein the canopy comprises vent apertures in a longitudinally extending centre portion of the canopy and vent apertures in an intermediate region of the canopy between a longitudinally extending edge region of the canopy and the centre portion, and the vent apertures in the centre portion are spaced closer together along the length of the canopy compared to the vent apertures in the intermediate region of the canopy.

9. A canopy according to claim 1 wherein the canopy comprises vent apertures in a longitudinally extending centre portion of the canopy and vent apertures in an intermediate region of the canopy between a longitudinally extending edge region of the canopy and the centre portion, and the vent apertures in the centre portion comprise a larger diameter than the vent apertures in the intermediate region of the canopy.

10. A canopy according to claim 3 wherein the canopy comprises vent apertures in an intermediate region of the canopy between the longitudinally extending edge region of the canopy and a centre portion of the canopy, and the vent apertures in the intermediate region are spaced closer together along the length of the canopy compared to the vent apertures in the edge region.

11. (canceled)

12. A canopy according to claim 1 wherein the canopy comprises vent apertures in a longitudinally extending centre portion of the canopy, vent apertures in a longitudinal edge region of the canopy, a vent cover over each of the vent apertures in the longitudinally centre portion of the canopy, and no vent covers over the vent apertures in the longitudinal edge region of the canopy.

13. A canopy according to claim 1 wherein the canopy comprises vent covers comprising a heavier weight sheet material than the sheet material of the main portion of the canopy.

14. A canopy according to claim 1 wherein the canopy comprises vent covers comprising a sheet material of lighter weight than or the same weight as the sheet material of the main portion of the canopy.

15. A canopy according to claim 1 wherein the canopy comprises vent covers comprising a relatively light weight sheet material having a weight of 50 to 200 g/m², or 50 to 100 g/m².

16. A canopy according to claim 1 wherein the canopy comprises vent covers comprising a relatively intermediate weight sheet material having a weight of 100 to 400 g/m², or 100 to 200 g/m².

17. A canopy according to claim 1 wherein the canopy comprises vent covers comprising a relatively heavy weight sheet material having a weight of 200 to 1000 g/m², or 200 to 600 g/m².

18. A canopy according to claim 1 wherein the canopy comprises vent covers in a first region of the canopy formed from a first sheet material and vent covers in a second region of the canopy formed from a second sheet material, the first sheet material having a heavier weight than the second sheet material.

19. A canopy according to claim 18 wherein the vent apertures in the first region of the canopy comprise a larger diameter than the vent apertures in the second region of the canopy.

20. A canopy according to claim 18 wherein the first region is a longitudinally extending central region of the canopy.

21. A canopy according to claim 20 wherein the second region is a longitudinally extending edge region of the canopy.

22. A canopy according to claim 18 wherein the canopy comprises vent covers formed from a third sheet material in a third region of the canopy, the third sheet material having a weight lighter than the first sheet material and heavier than the second sheet material.

23. A canopy according to claim 22 wherein the third region of the canopy is an intermediate region of the canopy between a longitudinally extending central region and a longitudinally extending edge region.

24. (canceled)

25. A canopy according to claim 1 wherein the vent cover is formed from a strip or sheet material formed in a cylinder, the cylinder folded or flattened to form an inner side and an outer side, the vent aperture being formed through the inner side, and the outer side of the cylinder forming the vent cover over the vent aperture.

26. A canopy according to claim 1 wherein the vent cover is attached to the sheet material of the canopy by a grommet forming the vent aperture through the sheet material of the canopy and the inner side.

27. A canopy according to claim 1 wherein the outer side is attached to the inner side along a longitudinal edge of the vent cover above the vent aperture relative to a ridge line of the canopy.

28. A canopy according to claim 1 wherein the outer side is attached to the inner side along a longitudinal edge of the vent cover below the vent aperture relative to a ridge line of the canopy.

29. A canopy according to claim 28 wherein the outer side is releasably attached to the inner side along a longitudinal edge of the vent cover below the vent aperture relative to the ridge line of the canopy.

30. A canopy according to claim 28 wherein the lateral dimension of the outer side is greater than the lateral dimension of the inner side so that the outer side arches outwardly from the vent aperture.

31. A canopy according to claim 1 wherein at least an upper portion of a lateral edge or edges of the outer side are attached to the inner side.

32. A canopy according to claim 2 wherein the canopy includes securing features within the region of the centre portion and each vent aperture in the centre portion is located adjacent to a said securing feature.

33. A canopy according to claim 2 wherein the vent apertures in the centre portion of the canopy are located on either side of a ridge of the canopy, and the vent apertures on each side of the ridge 12 are aligned along the canopy.

34. A canopy according to claim 2 wherein the vent apertures in the centre portion of the canopy are located on either side of a ridge of the canopy, and the vent apertures on one side of the ridge being staggered with the vent apertures on the other side of the ridge along the canopy.

35. A canopy according to claim 1 wherein the vent apertures are spaced apart in a longitudinal direction along the canopy.

36. A canopy according to claim 1 wherein a longitudinally extending centre portion is reinforced, the reinforced centre portion having a heavier construction than the sheet material on either side of the reinforced centre portion.

37-39. (canceled)

40. A canopy according to claim 3 wherein the longitudinal edge region of the canopy is reinforced, the reinforced longitudinal edge region having a heavier construction than the sheet material either side of or adjacent to the reinforced edge region.

41. A canopy according to claim 7 wherein the longitudinal intermediate region of the canopy is reinforced, the reinforced longitudinal intermediate region having a heavier construction than the sheet material either side of the reinforced edge region.

42-46. (canceled)

47. A canopy according to claim 34 wherein the canopy includes securing features within the region of the reinforced centre portion.

48. A canopy according to claim 47 wherein the canopy comprises a longitudinally extending flap in the reinforced centre portion, and the securing features are located in or on the flap.

49. A canopy according to claim 48 wherein the sheet material comprises at least two main webs of canopy material, longitudinal edge portions of the two main webs secured together in the reinforced centre portion to form the flap.

50. A canopy according to claim 48 wherein the sheet material comprises at least one main web of canopy material and the flap is folded from the main web along a longitudinal fold line in the reinforced centre portion to comprise at least two layers of the main web folded together.

51-54. (canceled)

55. A canopy according to claim 36 wherein the canopy, or at least the parts of the canopy that are outside the reinforced centre portion, are transparent or translucent to transmit light to plants beneath the canopy in use.

56-59. (canceled)

60. A canopy according to claim 1 wherein the sheet material comprises a woven sheet material woven from warp tapes and weft tapes, and a coating layer on one or both sides of the woven sheet material.

61-81. (canceled)

82. A canopy according to claim 1 wherein the canopy has a greater length than width and the canopy comprises:
at least one side extending between a longitudinal canopy ridge line and a longitudinal canopy edge, the side comprising:
a sheet material extending the length of the canopy for shielding weather, and
a venting region extending the length of the canopy comprising netting allowing air flow through the side of the canopy, the netting arranged alongside the sheet material to form a section of the side of the canopy, a longitudinal edge of the netting attached to a longitudinal edge of the sheet material,
a venting region cover arranged over the venting region and the longitudinal edge of the sheet material for shielding weather and movable to allow the air flow through the side of the canopy, and
a plurality of belts spaced apart along the longitudinal direction of the canopy, each belt extending across the venting region to reduce stretch of the venting region in a width direction of the canopy, an amount of stretch of the belts being less than an amount of stretch of the netting material without belts.

83-105. (canceled)

106. A canopy according to claim 1 wherein the canopy comprises a longitudinal fixing flap comprising the sheet material a distance from a longitudinal edge of the canopy, the fixing flap comprising securing features spaced apart along the fixing flap, and a portion of the width of the canopy outside the fixing flap forming a cover portion.

107-121. (canceled)

122. A method of sheltering a crop by positioning a canopy as claimed in claim 1 over the crop.

123. A method according to claim 122 wherein the method comprises positioning two or more said canopies side-by-side, each canopy comprising:
a longitudinal fixing flap comprising the sheet material a distance from a longitudinal edge of the canopy, the fixing flap comprising securing features spaced apart along the fixing flap, and a portion of the width of the canopy outside the fixing flap forming a cover portion, wherein
the fixing flap extends from a main portion of the canopy and the cover portion so that the cover portion extends from above the main portion of the canopy and from inside the securing features to extend outside the longitudinal edge of the main portion of the canopy, and
the cover portions of adjacent canopies overlapping.
